(19) United States
(12) Patent Application Publication
(10) Pub. No.: US 2013/0332410 A1
(43) Pub. Date: Dec. 12, 2013

(54) INFORMATION PROCESSING APPARATUS, ELECTRONIC DEVICE, INFORMATION PROCESSING METHOD AND PROGRAM

(71) Applicant: SONY CORPORATION, Tokyo (JP)

(72) Inventors: Yasuharu ASANO, Kanagawa (JP); Seiichi Takamura, Saitama (JP)

(73) Assignee: SONY CORPORATION, Tokyo (JP)

(21) Appl. No.: 13/869,422

(22) Filed: Apr. 24, 2013

(30) Foreign Application Priority Data
Jun. 7, 2012 (JP) 2012-129799

(51) Int. Cl. G06F 17/30

(52) U.S. Cl. CPC G06F 17/30345
USPC 707/609

(57) ABSTRACT

There is provided an information processing apparatus including a DB updating unit updating an action pattern database used to detect an action pattern of a user based on a sensor detection result, a text information acquiring unit acquiring text information which the user inputs in a device, and a text information analyzing unit acquiring information related to an action pattern from the text information. In a case where the information related to the action pattern is acquired from the text information, the DB updating unit updates the action pattern database using the acquired information.

### BACKGROUND

The present disclosure relates to an information processing apparatus, an electronic device, an information processing method and a program.

It is focused on a technique of mounting a motion sensor on a mobile terminal such as a mobile phone and automatically detecting and recording a use action history. For example, following Japanese Patent Laid-Open No. 2008-003655 discloses a technique of using a motion sensor such as an acceleration sensor and a gyro sensor and detecting a walking operation, a running operation, a right-turning and left-turning operation and a still state. The patent literature discloses a method of calculating a walking pitch, walking power and a rotation angle from output data of the motion sensor and detecting the walking operation, the running operation, the right-turning and left-turning operation and the still state using the calculation result.

Further, the patent literature discloses a method of detecting a user's action pattern by statistical processing with an input of operation and state patterns such as the types of these operations and state, the period of time during which the operations and the state continue and the number of operations. By using the above method, it is possible to acquire an action pattern such as “sauntering” and “restless operation” as time-series data. However, the action pattern acquired in this method mainly indicates a user's operation and state performed in a relatively short period of time. Therefore, it is difficult to estimate, from an action pattern history, specific action content such as “I shopped at a department store today” and “I ate at a hotel restaurant yesterday.”

The action pattern acquired using the method disclosed in following Japanese Patent Laid-Open No. 2008-003655 denotes an accumulation of actions performed in a relatively period of time. Also, individual actions themselves forming the action pattern are not intentionally performed by the user. By contrast, specific action content is intentionally performed by the user in most cases and is highly entertaining, which is performed over a relatively long period of time. Therefore, it is difficult to estimate the above specific action content from an accumulation of actions performed during a short period of time. However, recently, there is developed a technique of detecting a highly-entertaining action pattern performed over a relatively long period of time, from an action pattern in a relatively short period of time acquired using a motion sensor (see following Japanese Patent Laid-Open No. 2011-081431).

### SUMMARY

When the technique disclosed in above Japanese Patent Laid-open No. 2011-081431 is applied, it is possible to detect an action pattern taken by a user. However, the detection processing is performed using information acquired from a position sensor or motion sensor, and therefore there is a case where the action pattern estimation accuracy is insufficient. To be more specific, there occurs a difference in information acquired from the motion sensor of each user. For example, a detection result varies depending on a portable state such as a state where a device mounting a motion sensor is put in a pocket to carry it and a case where it is put in a bag to carry it, and therefore an estimation result may vary. Therefore, it is requested to develop a technique of enhancing the action pattern estimation accuracy using other information than that of a position sensor or motion sensor.

Therefore, the present disclosure is devised in view of the above conditions and intends to provide a new improved information processing apparatus, electronic device, information processing method and program that can improve the action pattern estimation accuracy.

According to an embodiment of the present disclosure, there is provided an information processing apparatus including a DB updating unit updating an action pattern database used to detect an action pattern of a user based on a sensor detection result, a text information acquiring unit acquiring text information which the user inputs in a device, and a text information analyzing unit acquiring information related to an action pattern from the text information. In a case where the information related to the action pattern is acquired from the text information, the DB updating unit updates the action pattern database using the acquired information.

According to another embodiment of the present disclosure, there is provided an electronic device including a communication unit accessing an action pattern database used to detect an action pattern of a user based on a sensor detection result in a case where information related to an action pattern is acquired from text information which the user inputs in the electronic device, the action pattern database being updated using the acquired information, and an action pattern information acquiring unit acquiring the information related to the action pattern corresponding to the sensor detection result and the text information, from the action pattern database.

According to another embodiment of the present disclosure, there is provided an information processing method including updating an action pattern database used to detect an action pattern of a user based on a sensor detection result. In a case where information related to an action pattern is acquired from text information which the user inputs in a device, the action pattern database is updated using the acquired information.

According to another embodiment of the present disclosure, there is provided an information processing method including accessing an action pattern database used to detect an action pattern of a user based on a sensor detection result in a case where information related to an action pattern is acquired from text information which the user inputs in an electronic device, the action pattern database being updated using the acquired information, and acquiring the information related to the action pattern corresponding to the sensor detection result and the text information, from the action pattern database.

According to another embodiment of the present disclosure, there is provided a program for causing a computer to realize a DB updating function of updating an action pattern database used to detect an action pattern of a user based on a sensor detection result, a text information acquiring function of acquiring text information which the user inputs in a device, and a text information analyzing function of acquiring information related to an action pattern from the text information. In a case where the information related to the action pattern is acquired from the text information, the DB updating function updates the action pattern database using the acquired information.

According to another embodiment of the present disclosure, there is provided a program for causing a computer to realize a communication function of accessing an action pattern database used to detect an action pattern of a user based on a sensor detection result in a case where information related to an action pattern is acquired from text information which the user inputs in an electronic device, the action pattern database being updated using the acquired information, and an action pattern information acquiring function of acquiring the information related to the action pattern corresponding to the sensor detection result and the text information, from the action pattern database.

Also, according to another embodiment of the present disclosure, there is provided a computer-readable storage medium recording the above program.

According to the embodiments of the present disclosure described above, it is possible to improve the action pattern estimation accuracy.

### BRIEF DESCRIPTION OF THE DRAWINGS

FIG. 1 is an explanatory diagram for explaining a configuration example of an action/situation analysis system;

FIG. 2 is an explanatory diagram for explaining a function of a motion/state recognizing unit;

FIG. 3 is an explanatory diagram for explaining a function of a motion/state recognizing unit;

FIG. 4 is an explanatory diagram for explaining a function of a GIS information acquiring unit;

FIG. 5 is an explanatory diagram for explaining a function of a GIS information acquiring unit;

FIG. 6 is an explanatory diagram for explaining a function of a GIS information acquiring unit;

FIG. 7 is an explanatory diagram for explaining a function of a GIS information acquiring unit;

FIG. 8 is an explanatory diagram for explaining a function of an action/situation recognizing unit;

FIG. 9 is an explanatory diagram for explaining a function of an action/situation recognizing unit;

FIG. 10 is an explanatory diagram for explaining an action/situation pattern decision method;

FIG. 11 is an explanatory diagram for explaining a calculation method of score distribution using a geo histogram;

FIG. 12 is an explanatory diagram for explaining a calculation method of score distribution using machine learning;

FIG. 13 is an explanatory diagram for explaining an example of a detected action/situation pattern;

FIG. 14 is an explanatory diagram for explaining a configuration example of an action/situation recognition system according to an embodiment of the present disclosure;

FIG. 15 is an explanatory diagram for explaining a detailed configuration of an action/situation recognition system according to the embodiment;

FIG. 16 is an explanatory diagram for explaining an operation of an action/situation recognition system according to the embodiment;

FIG. 17 is an explanatory diagram for explaining an operation of an action/situation recognition system according to the embodiment;

FIG. 18 is an explanatory diagram for explaining a detailed configuration of an action/situation recognition system according to an alternation example of the embodiment;

FIG. 19 is an explanatory diagram for explaining an operation of an action/situation recognition system according to an alternation example of the embodiment;

FIG. 20 is an explanatory diagram for explaining an operation of an action/situation recognition system according to an alternation example of the embodiment;

FIG. 21 is an explanatory diagram for explaining an operation of an action/situation recognition system according to an alternation example of the embodiment;

FIG. 22 is an explanatory diagram for explaining an operation of an action/situation recognition system according to an alternation example of the embodiment;

FIG. 23 is an explanatory diagram for explaining a screen configuration example of an application using an action pattern recognition result according to the present embodiment; and

FIG. 24 is an explanatory diagram for explaining a hardware configuration example that can realize the functions of a system and each device according to the embodiment.

### DETAILED DESCRIPTION OF THE EMBODIMENT(S)

Hereinafter, preferred embodiments of the present disclosure will be described in detail with reference to the appended drawings. Note that, in this specification and the appended drawings, structural elements that have substantially the same function and structure are denoted with the same reference numerals, and repeated explanation of these structural elements is omitted.

[Regarding Flow of Explanation]

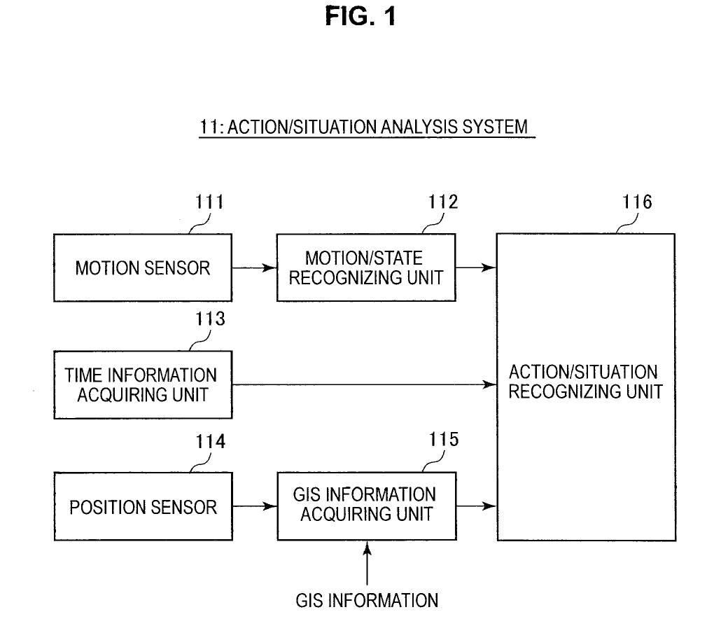

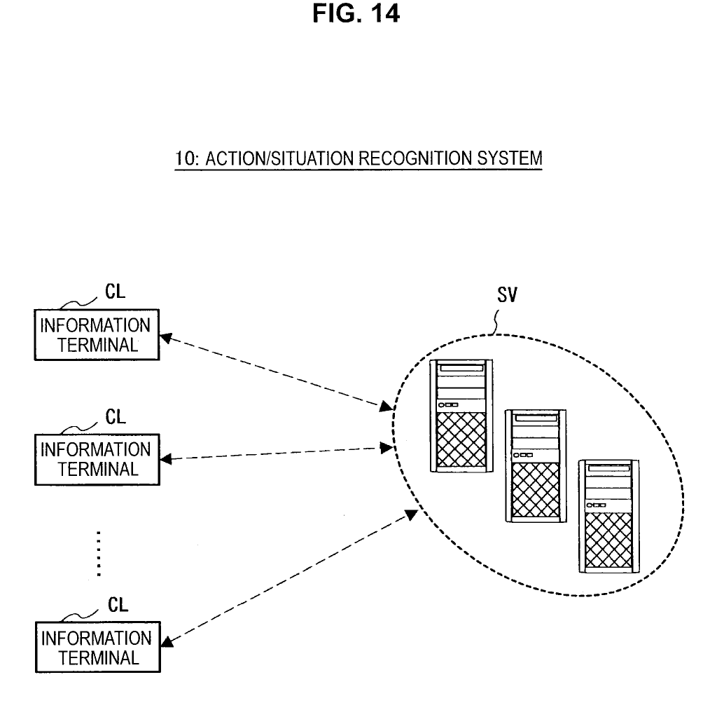

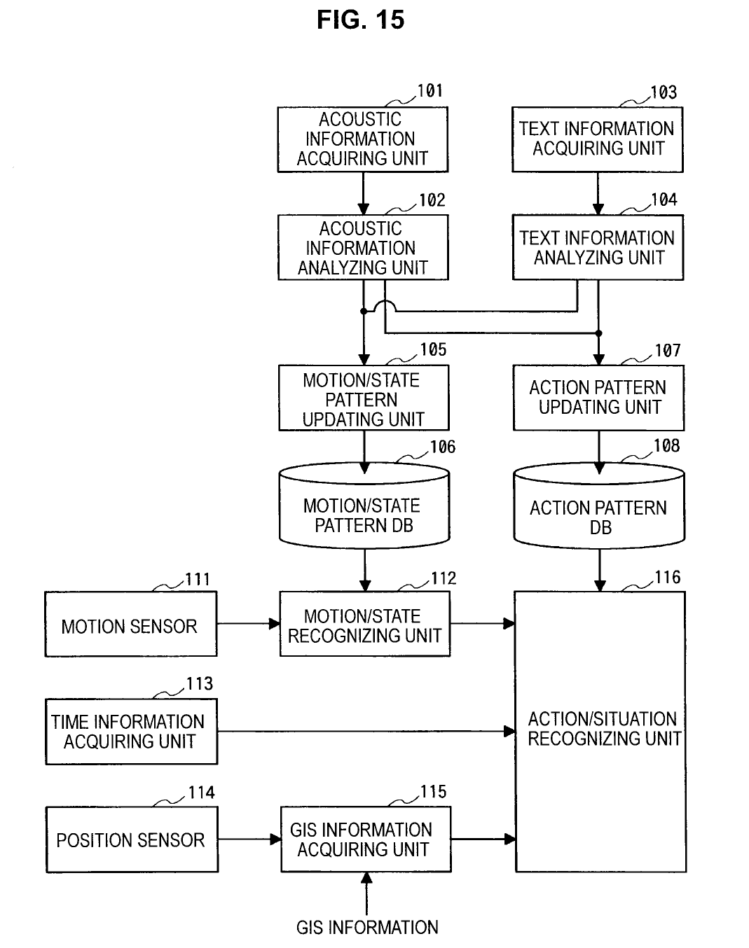

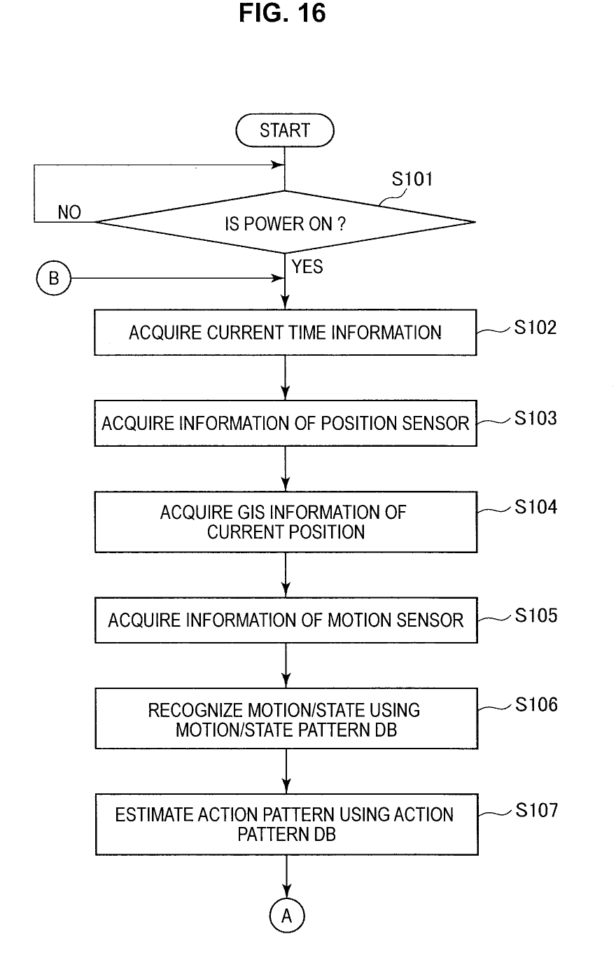

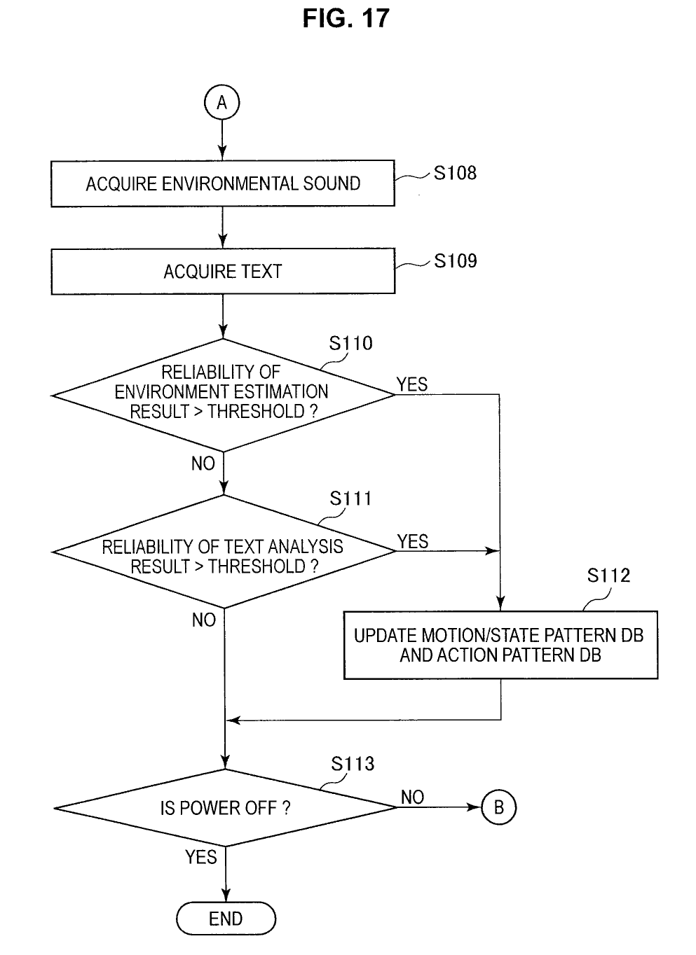

Here, a flow of explanation disclosed herein is simply described. First, with reference to FIG. 1 to FIG. 13, an action pattern recognition technique related to a technique of the present embodiment is explained. Next, with reference to FIG. 14 and FIG. 15, a configuration of an action/situation recognition system according to an embodiment of the present disclosure is explained. Next, with reference to FIG. 16 and FIG. 17, an operation of an action/situation recognition system according to the present embodiment is explained.

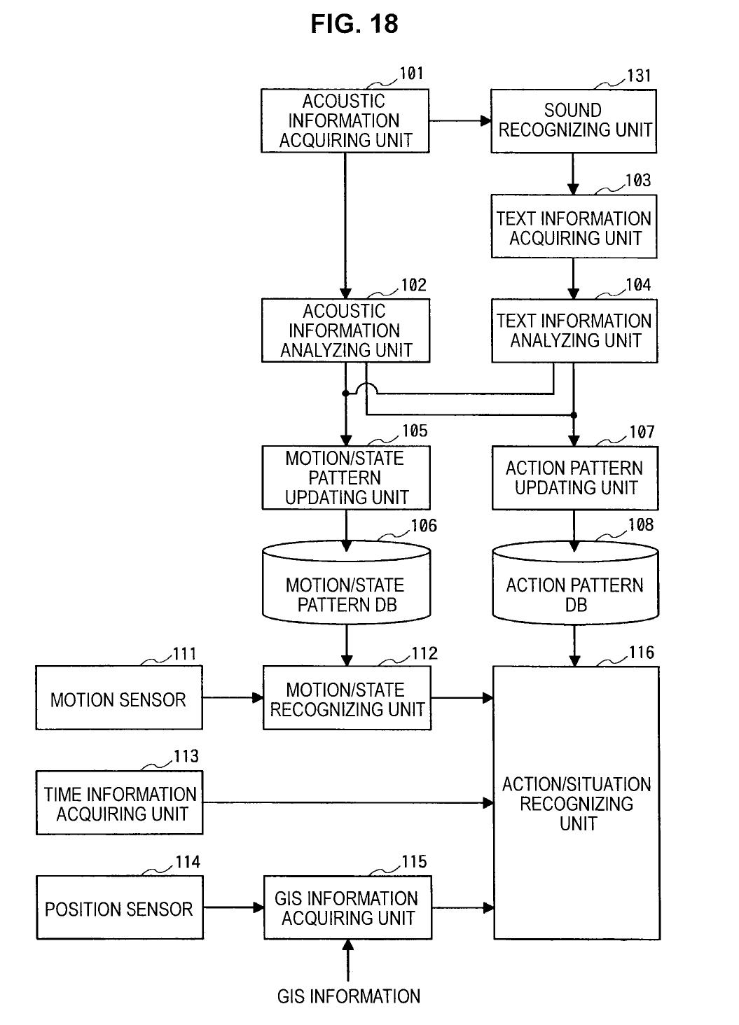

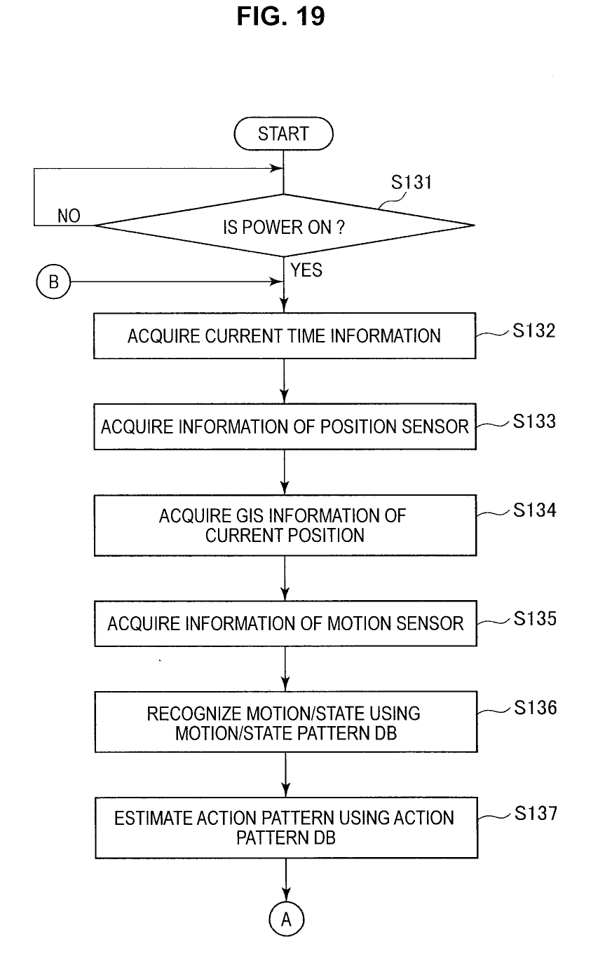

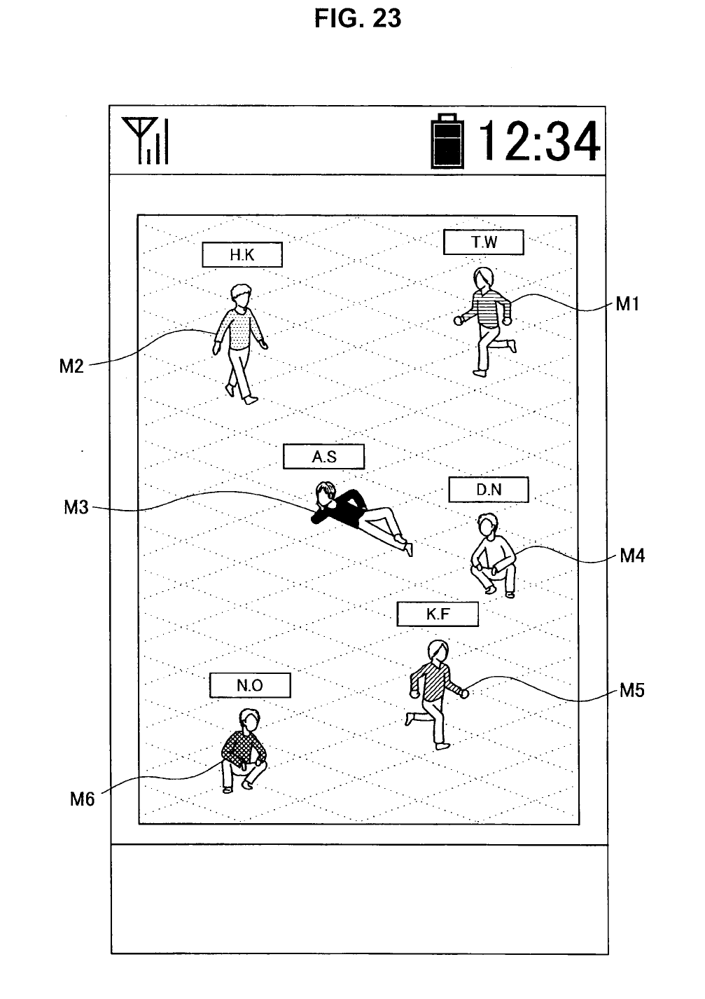

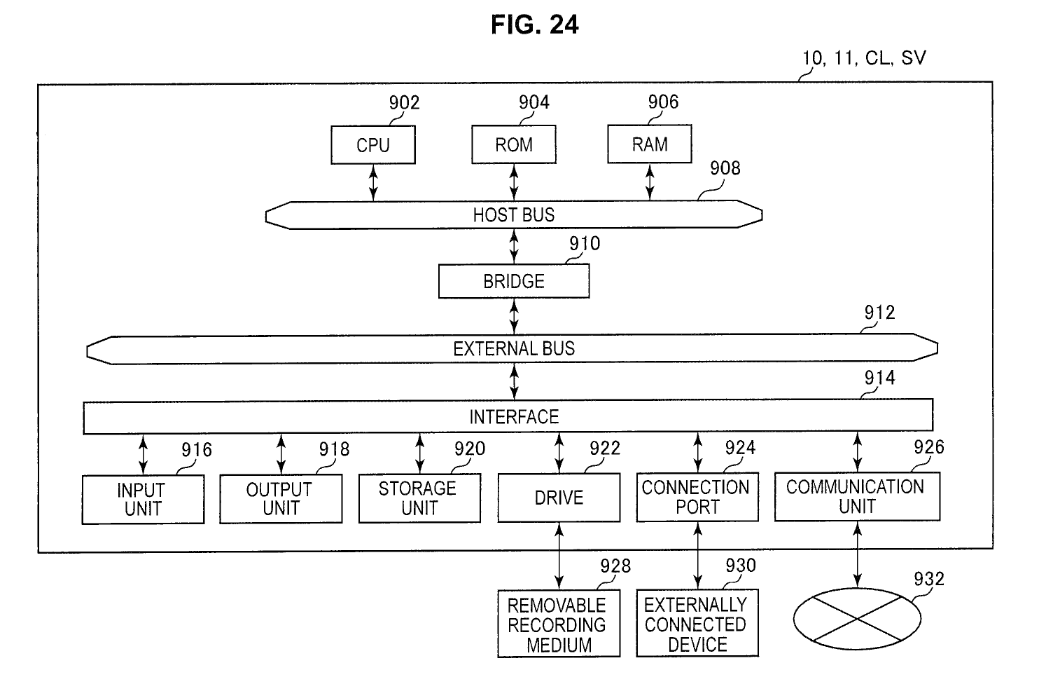

Next, with reference to FIG. 18, a configuration of an action/situation recognition system according to an alternation example of the embodiment is explained. Next, with reference to FIG. 19 to FIG. 22, an operation of an action/situation recognition system according to an alternation example of the embodiment is explained. Next, with reference to FIG. 23, a screen configuration example of an application using an action pattern recognition result according to the embodiment is explained. Next, with reference to FIG. 24, a hardware configuration example that can realize the functions of a system and each device according to the embodiment is explained.

Finally, technical ideas according to the embodiment are summarized and an operational effect acquired from the technical ideas is simply explained.

### (Explanation Items)

### 1: Introduction

1-1: Action pattern recognition technique

1-2: Outline of embodiment
1-2-1: Updating of pattern DB using text information
1-2-2: Updating of pattern DB using environmental sound
   2: Details of embodiment

2-1: Example of system configuration

2-2: Updating of pattern DB using text information and acoustic information
2-2-1: Functional configuration
2-2-2: Flow of processing

2-3: (Alternation example) Application of sound recognition technique
2-3-1: Functional configuration
2-3-2: Flow of processing

2-4: Example of screen display (one example of application)

3: Hardware configuration example

### 4: Summary

### 1: INTRODUCTION

First, an action pattern recognition technique related to a technique of the present embodiment is explained.

### 1-1: Action Pattern Recognition Technique

The action pattern recognition technique explained herein relates to a technique of detecting a user's action and state using information related to a user's action and state detected by a motion sensor or the like and position information detected by a position sensor or the like.

Also, as the motion sensor, for example, a triaxial acceleration sensor (including an acceleration sensor, a gravity detection sensor and a fall detection sensor) and a triaxial gyro sensor (including an angular velocity sensor, a stabilization sensor and a terrestrial magnetism sensor) are used. Also, for example, it is possible to use information of GPS (Global Positioning System), RFID (Radio Frequency Identification), Wi-Fi access points or wireless base stations as the position sensor. By using their information, for example, it is possible to detect the latitude and longitude of the current position.

(System Configuration of Action/Situation Analysis System 11)

First, with reference to FIG. 1, an explanation is given to the system configuration of the action/situation analysis system 11 that can realize the action pattern recognition technique as described above. FIG. 1 is an explanatory diagram for explaining the entire system configuration of the action/situation analysis system 11.

Here, in the present specification, expression “motion/state” and expression “action/situation” are separated by the following meanings. The expression “motion/state” denotes an action performed by the user in a relatively short period of time of around several seconds to several minutes, and indicates behavior such as “walking,” “running,” “jumping” and “still.” Also, this behavior may be collectively expressed as “motion/state pattern” or “LC (Low-Context) action.” Meanwhile, the expression “action/situation” denotes living activities performed by the user in a longer period of time than that in the case of “motion/state,” and indicates behavior such as “eating,” “shopping” and “working.” Also, this behavior may be collectively expressed as “action/situation pattern” or “HC (High-Context) action.”

As illustrated in FIG. 1, the action/situation analysis system 11 mainly includes a motion sensor 111, a motion/state recognizing unit 112, a time information acquiring unit 113, a position sensor 114, a GIS information acquiring unit 115 and an action/situation recognizing unit 116.

Also, the action/situation analysis system 11 may include an application AP or service SV using an action/situation pattern detected by the action/situation recognizing unit 116. Also, it may be formed such that an action/situation pattern use result by the application AP and user profile information are input in the action/situation recognizing unit 116.

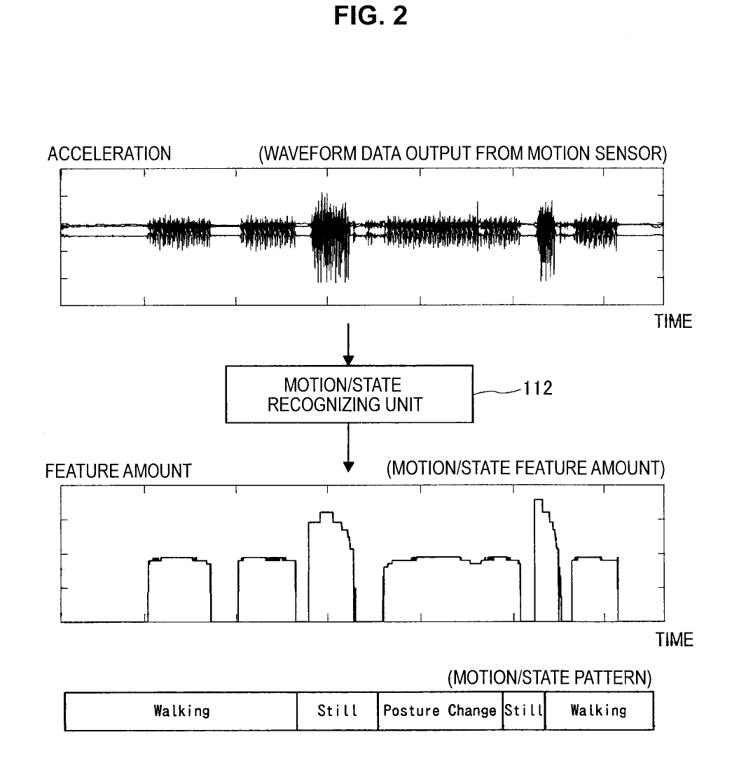

First, when the user acts, the motion sensor 111 detects a change of acceleration or rotation around the gravity axis (hereinafter referred to as “sensor data”). The sensor data detected by the motion sensor 111 is input in the motion/state recognizing unit 112 as illustrated in FIG. 2.

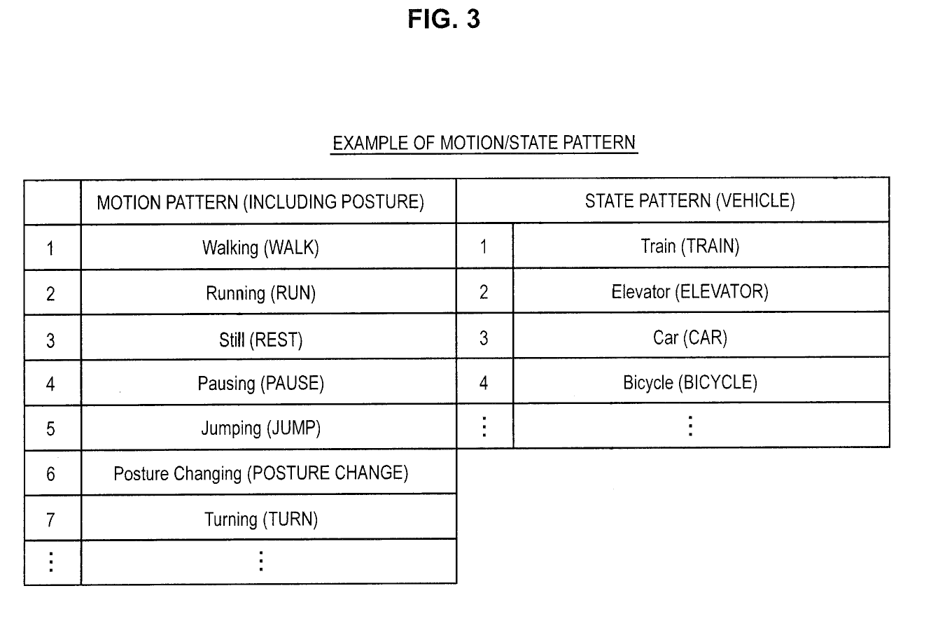

When the sensor data is input, as illustrated in FIG. 2, the motion/state recognizing unit 112 detects a motion/state pattern using the input sensor data. As illustrated in FIG. 3, examples of the motion/state pattern that can be detected by the motion/state recognizing unit 112 include “walking,” “running,” “still,” “jumping,” “train (riding/non-riding)” and “elevator (riding/non-riding/rising/falling).” The motion/.state pattern detected by the motion/state recognizing unit 112 is input in the action/situation recognizing unit 116.

The position sensor 114 continuously or intermittently acquires position information indicating a user's location (hereinafter referred to as “current position”). For example, the position information of the current position is expressed by latitude and longitude. The position information of the current position acquired by the position sensor 114 is input in the GIS information acquiring unit 115.

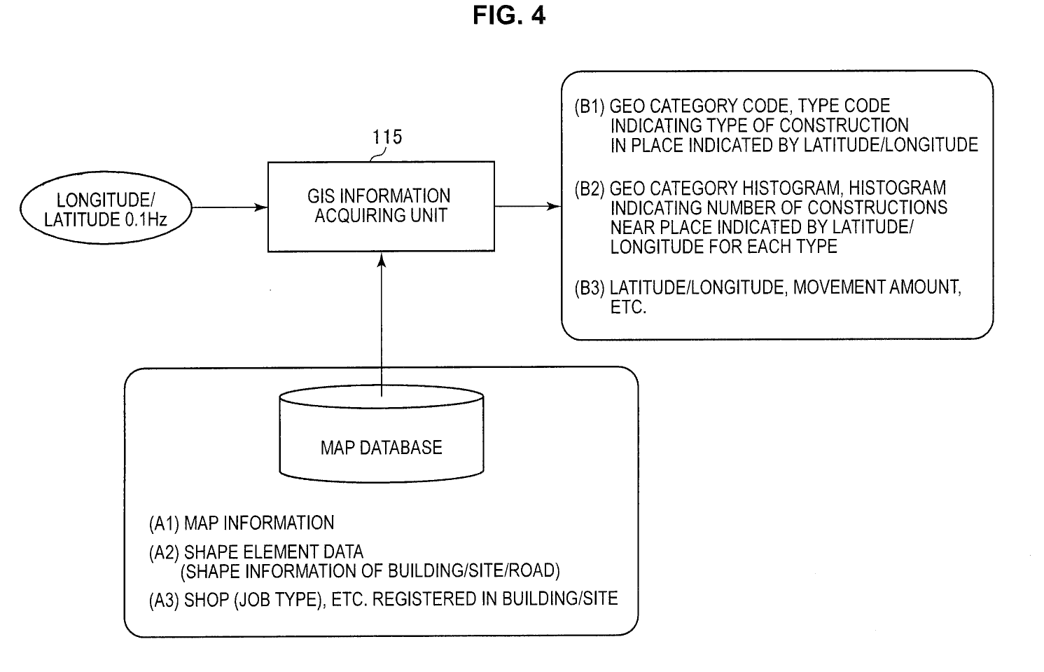

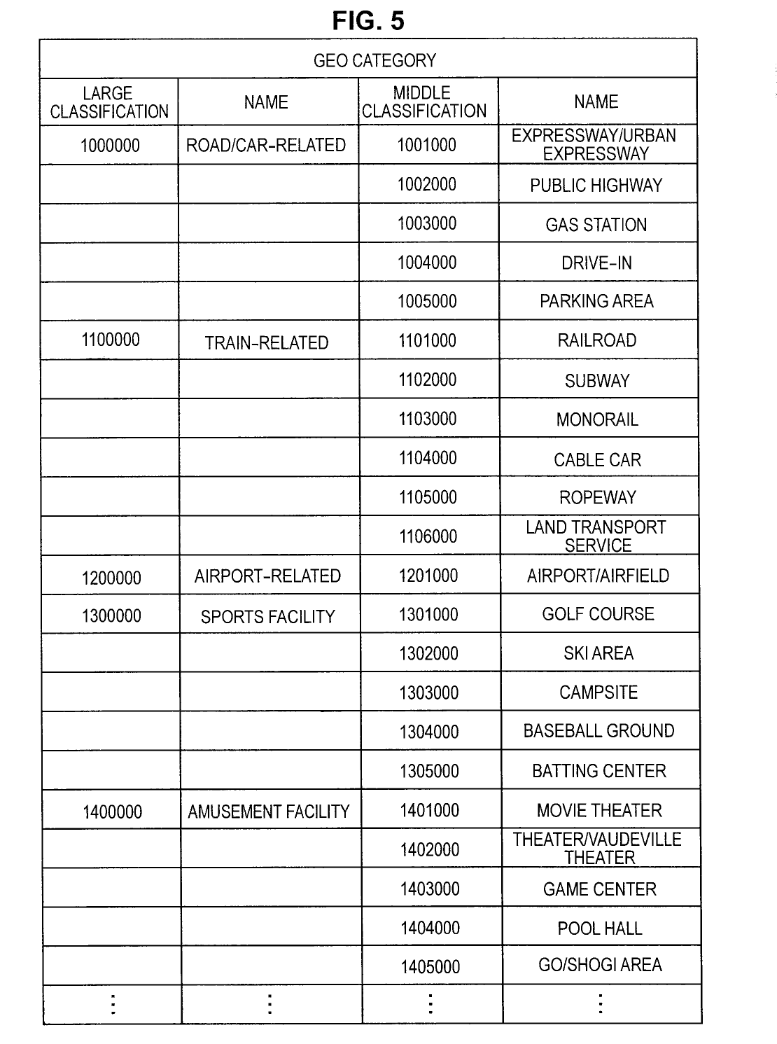

When the position information of the current position is input, the GIS information acquiring unit 115 acquires GIS (Geographic Information System) information. Subsequently, as illustrated in FIG. 4, the GIS information acquiring unit 115 detects an attribute of the current position using the acquired GIS information. For example, the GIS information includes map information and various kinds of information acquired by an artificial satellite or field survey, which is information used for scientific research, management of land, facilities or road and urban design. When the GIS information is used, it is possible to decide an attribute of the current position. For example, the GIS information acquiring unit 115 expresses the attribute of the current position using identification information called “geo category code” (for example, see FIG. 5).

As illustrated in FIG. 5, the geo category code denotes a classification code to classify the type of information related to a place. This geo category code is set depending on, for example, a construction type, a landform shape, a geological feature, locality, and so on. Therefore, by specifying the geo category code of the current position, it is possible to recognize an environment in which the user is placed, in some degree.

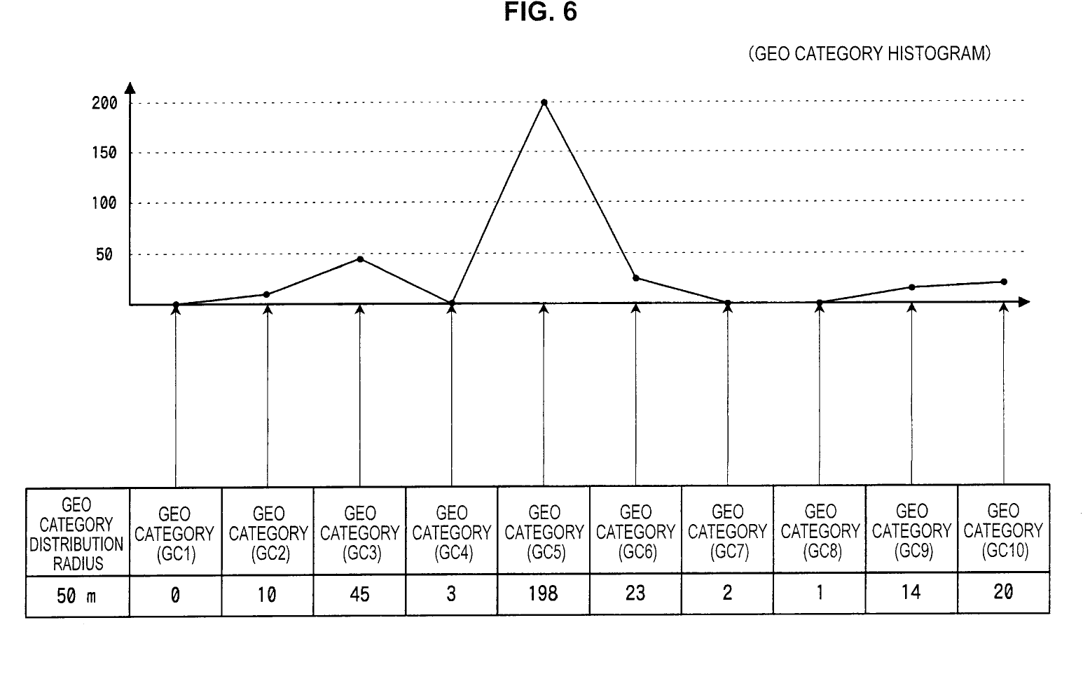

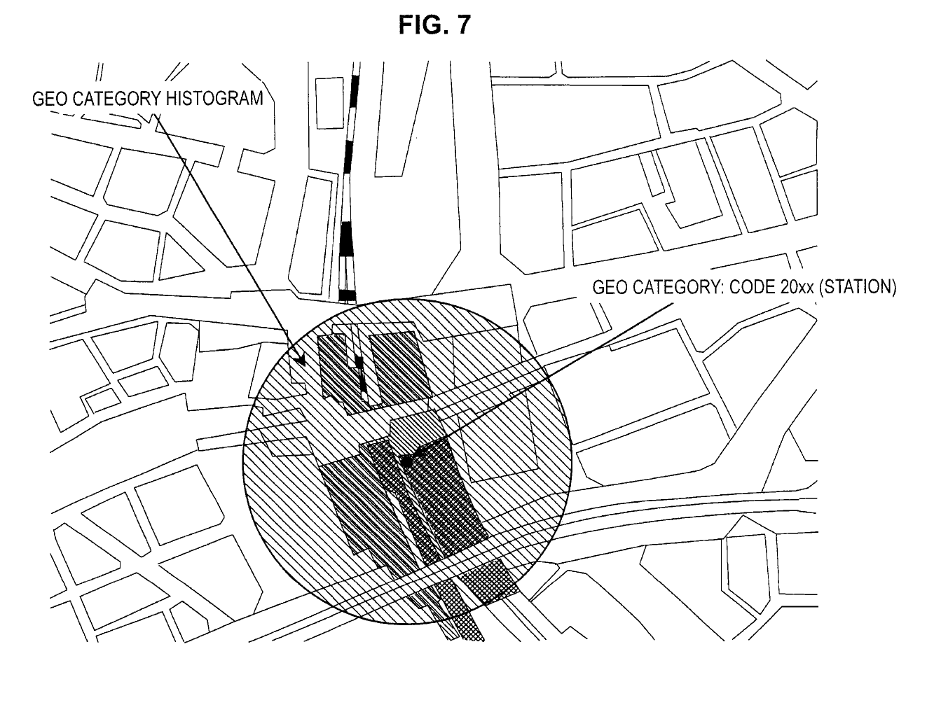

The GIS information acquiring unit 115 refers to the acquired GIS information, specifies a construction or the like in the current position and the periphery of the current position, and extracts a geo category code corresponding to the construction or the like. The geo category code selected by the GIS information acquiring unit 115 is input in the action/situation recognizing unit 116. Also, in a case where there are many constructions or the like in the periphery of the current position, the GIS information acquiring unit 115 may extract the geo category code of each construction and input information such as geo histograms illustrated in FIG. 6 and FIG. 7, as information related to the extracted geo category, in the action/situation recognizing unit 116.

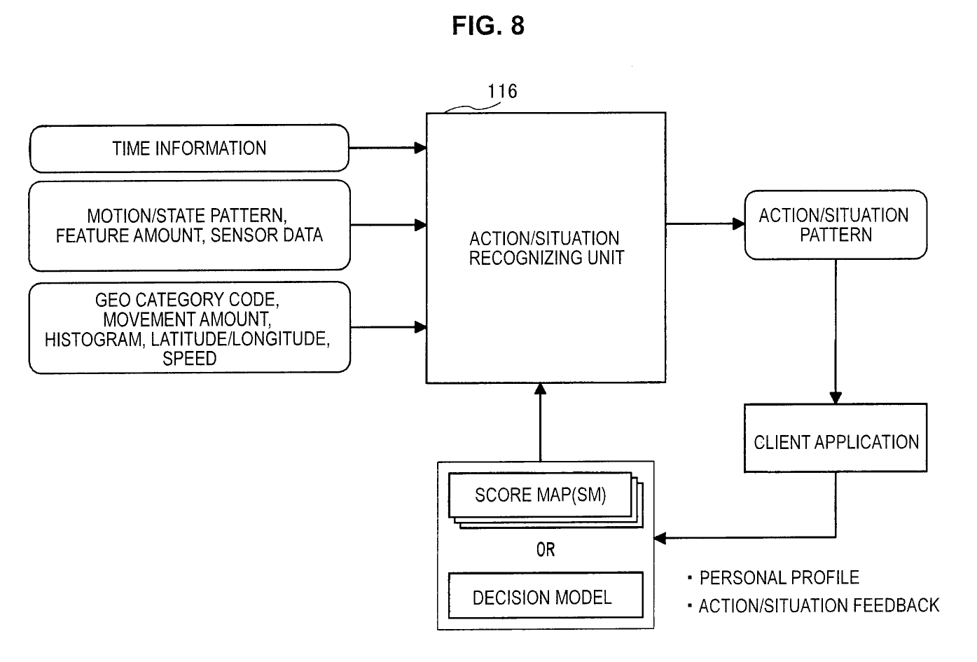

As illustrated in FIG. 8, the action/situation recognizing unit 116 receives an input of the motion/state pattern from the motion/state recognizing unit 112 and an input of the geo category code from the GIS information acquiring unit 115. Also, the action/situation recognizing unit 116 receives an input of time information from the time information acquiring unit 113. This time information includes information indicating the time at which the motion sensor 111 acquires the sensor data. Also, this time information may include information indicating the time at which the position sensor 114 acquires the position information. Also, the time information may include information such as day information, holiday information and date information, in addition to the information indicating the time.

When the above information is input, the action/situation recognizing unit 116 detects an action/situation pattern based on the input motion/state pattern, the input geo category code (or the geo histograms, for example) and the input time information. At this time, the action/situation recognizing unit 116 detects the action/situation pattern using decision processing based on rules (hereinafter referred to as “rule base decision”) and decision processing based on learning models (hereinafter referred to as “learning model decision”). In the following, the rule base decision and the learning model decision are simply explained.

(Regarding Rule Base Decision)

First, the rule base decision is explained. The rule base decision denotes a method of assigning scores to combinations of geo category codes and action/situation patterns and deciding an appropriate action/situation pattern corresponding to input data based on the scores.

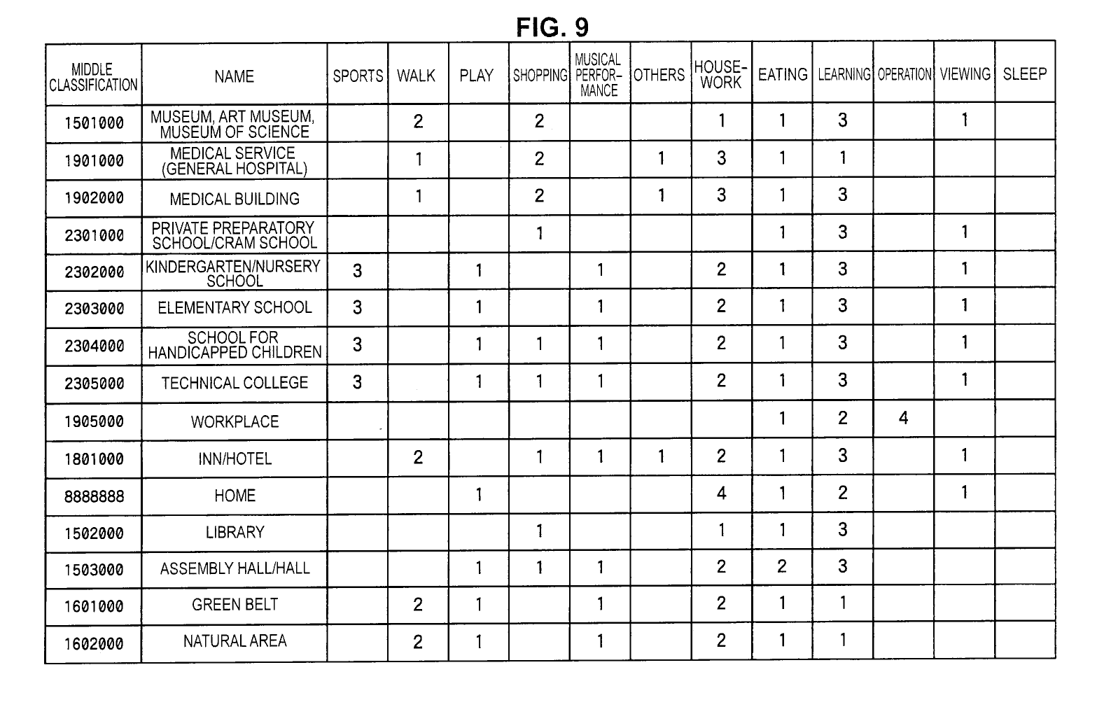

A score assignment rule is realized by a score map SM as illustrated in FIG. 9. The score map SM is prepared for each time information, such as date, time zone and day. For example, a score map SM supporting Monday in the first week of March is prepared. Further, the score map SM is prepared for each motion/state pattern, such as walking, running and train. For example, a score map SM during walking is prepared. Therefore, a score map SM is prepared for each of combinations of time information and motion/state patterns.

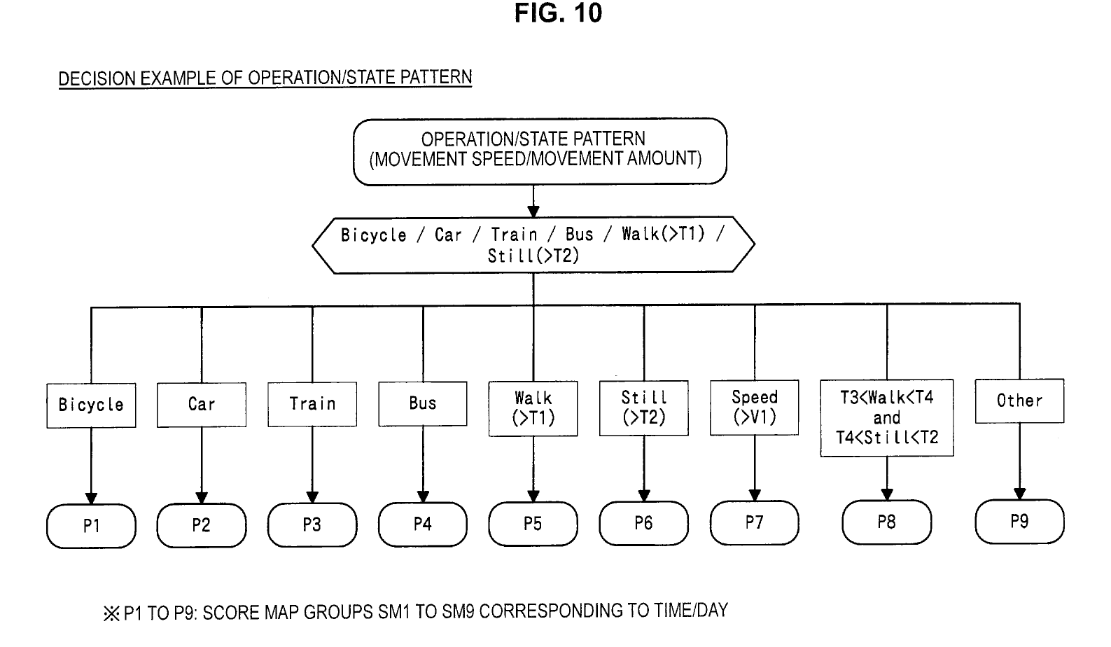

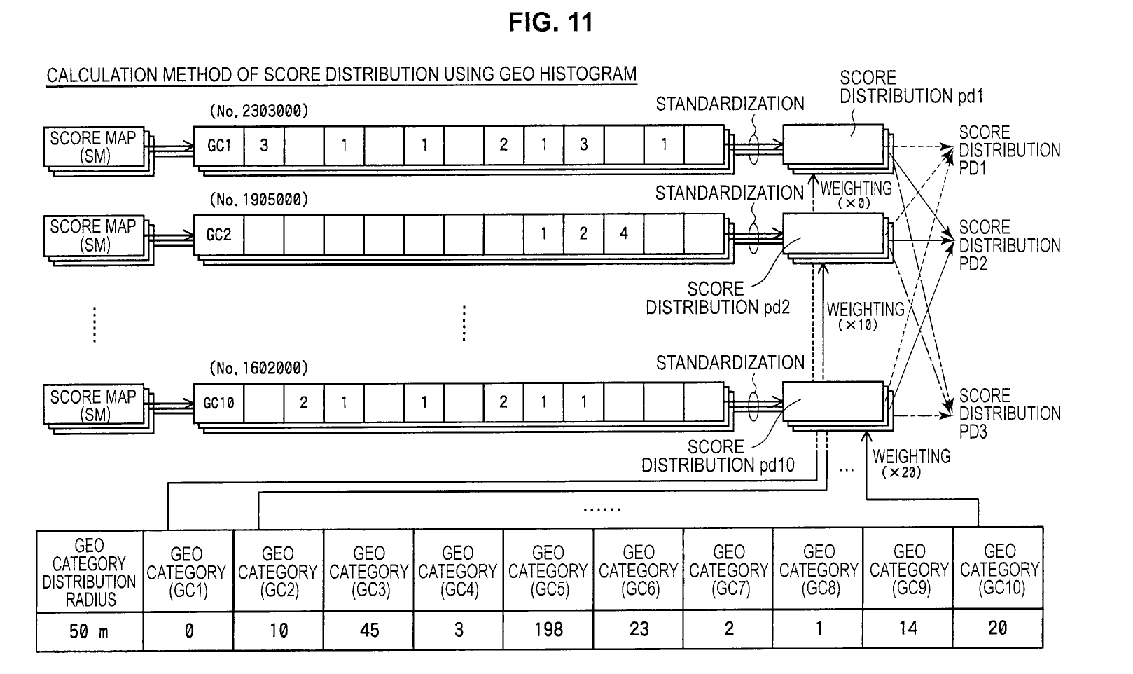

As illustrated in FIG. 10, the action/situation recognizing unit 116 selects a score map SM suitable to input time information and motion/state pattern, from multiple score maps SM prepared in advance. Also, as illustrated in FIG. 11, the action/situation recognizing unit 116 extracts scores corresponding to a geo category code, from the selected score map SM. By this processing, taking into account a state of the current position at the acquisition time of sensor data, the action/situation recognizing unit 116 can extract the score of each action/situation pattern existing in the score map SM.

Next, the action/situation recognizing unit 116 specifies the maximum score among the extracted scores and extracts an action/situation pattern corresponding to the maximum score. Thus, a method of detecting an action/situation pattern is the rule base decision. Here, a score in the score map SM indicates an estimated probability that the user takes an action/situation pattern corresponding to the score. That is, the score map SM indicates score distribution of action/situation patterns estimated to be taken by the user in a state of the current position expressed by a geo category code.

For example, at around three o'clock on Sunday, it is estimated that the user in a department store is highly likely to be “shopping.” However, at around 19 o'clock in the same department store, it is estimated that the user in the department store is highly likely to be “eating.” Thus, in a certain place, score distribution of action/situation patterns performed by the user denotes the score map SM (accurately, score map SM group).

For example, the score map SM may be input in advance by the user himself/herself or somebody else, or may be acquired using machine learning or the like. Also, the score map SM may be optimized by personal profile information PR or action/situation feedback FB (right and wrong of output action/situation pattern) acquired from the user. As the profile information PR, for example, age, gender, job or home information and workplace information are used. The above is specific processing content of the rule base decision.

(Regarding Learning Model Decision)

Next, the learning model decision is explained. The learning model decision is a method of generating a decision model to decide an action/situation pattern by a machine learning algorithm and deciding an action/situation pattern corresponding to input data by the generated decision model.

As the machine learning algorithm, for example, a k-men method, a nearest neighbor method, SVM, HMM and boosting are available. Here, SVM is an abbreviation of “Support Vector Machine.” Also, HMM is an abbreviation of “Hidden Markov Model.” In addition to these methods, there is a method of generating a decision model using an algorithm construction method based on genetic search disclosed in Japanese Patent Laid-Open No. 2009-48266.

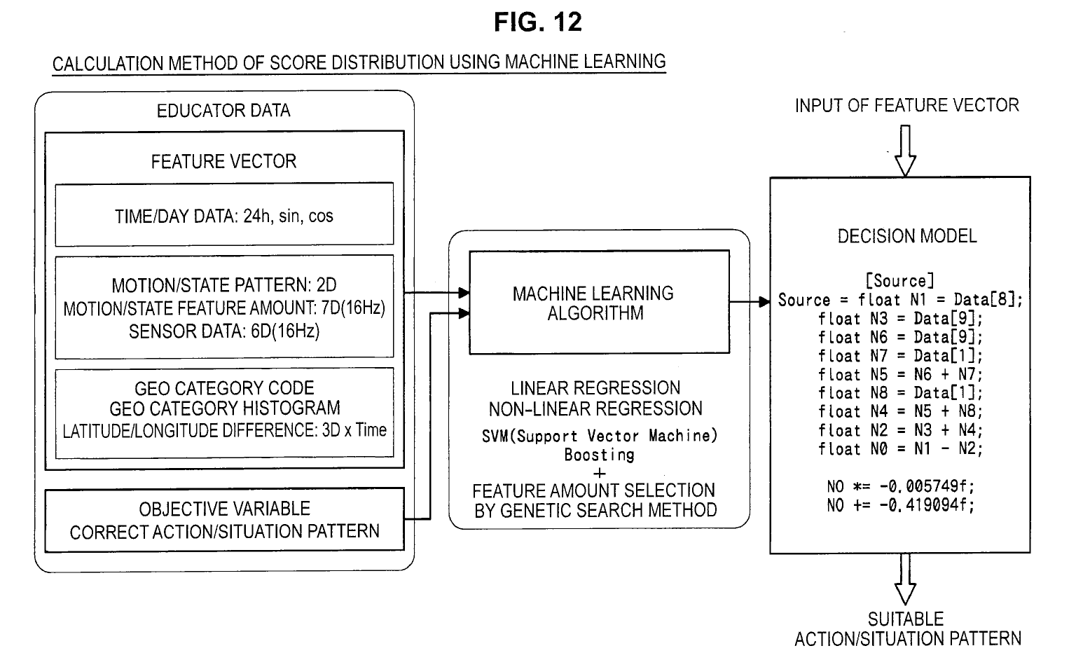

As a feature amount vector input in a machine learning algorithm, for example, as illustrated in FIG. 12, time information, motion/state pattern, geo category code (or geo category histogram), sensor data and position information of the current position are available. Here, in the case of using an algorithm construction method based on generic search, a generic search algorithm is used on a feature amount vector selection stage in learning process. First, the action/situation recognizing unit 116 inputs a feature amount vector in which a correct action/situation pattern is known, in a machine learning algorithm, as learning data, and generates a decision model to decide the accuracy of each action/situation pattern or an optimal action/situation pattern.

Next, the action/situation recognizing unit 116 inputs input data in the generated decision model and decides an action/situation pattern estimated to be suitable to the input data. However, in a case where it is possible to acquire right and wrong feedback with respect to a result of decision performed using the generated decision model, the decision model is reconstructed using the feedback. In this case, the action/situation recognizing unit 116 decides an action/situation pattern estimated to be suitable to the input data using the reconstructed decision model. The above is specific processing content of the learning model decision.

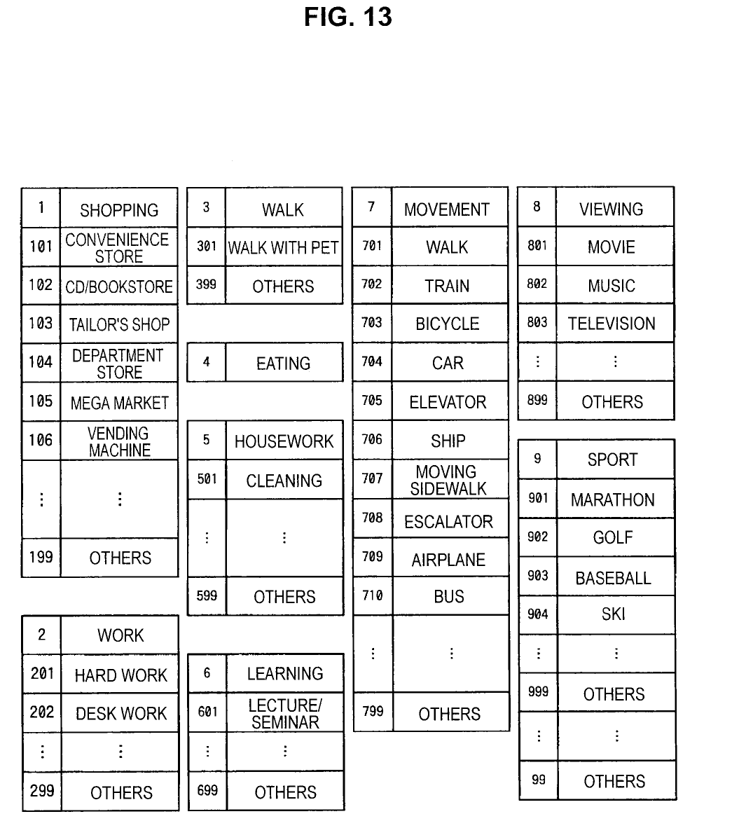

By the above-described method, the action/situation recognizing unit 116 detects an action/situation pattern as illustrated in FIG. 13. Subsequently, the action/situation pattern detected by the action/situation recognizing unit 116 is used to provide recommended service SV based on the action/situation pattern or used by an application AP that performs processing based on the action/situation pattern.

The system configuration of the action/situation analysis system 11 has been described above. Techniques according to an embodiment described below relate to functions of the action/situation analysis system 11 described above. Also, regarding detailed functions of the action/situation analysis system 11, for example, the disclosure of Japanese Patent Laid-Open No. 2011-081431 serves as a reference.

### 1-2: Outline of Embodiment

First, an outline of a technique according to the present embodiment is explained. The technique according to the present embodiment relates to an updating method of a pattern database (hereinafter referred to as “pattern DB”) used for the above action pattern recognition technique. The above action pattern recognition technique uses sensor data. Accordingly, an action pattern recognition result may depend on a method of carrying an information terminal by a user or a usage environment. Therefore, the technique according to the present embodiment suggests a method of updating the pattern DB so as to improve tolerance for noise due to a carry method or usage environment.

(1-2-1: Updating of Pattern DB Using Text Information)

As one method, there is suggested a pattern DB updating method using text information.

As the text information, for example, it is possible to use texts input in e-mail, calendar, to-do list, memo, blog, Twitter (registered trademark), Facebook (registered trademark) or other social media. Also, it is possible to use the text information in combination with an input of information with respect to applications such as a transfer guidance and route search or access point search information. In the following, although such a combination is not referred to in detail, it should be noted that this application is naturally considered.

There are many cases where the text information as above includes information reflecting a user's action in real time or information associated with the time and date of the action. Therefore, by analyzing the text information and reflecting the analysis result to a pattern DB, it is possible to further improve the accuracy of action pattern recognition.

For example, even in a case where it is decided from sensor data and position information that the user's action pattern is “getting on a train,” if the user writes a phrase “I boarded a boat for the first time!” in the text information, it is considered that an action pattern “boarding a boat” is correct. In this case, by amending the corresponding record in the pattern DB to “boarding a boat,” it is possible to distinguish between an action pattern “getting on a train” and an action pattern “boarding a boat.” That is, it is possible to improve the accuracy of action pattern recognition.

(1-2-2: Updating of Pattern DB Using Environmental Sound)

Also, as another method, there is suggested a pattern DB updating method using environmental sound.

The environmental sound described herein denotes arbitrary sound information that can be collected by an information terminal used by a user. When the user is getting on a train, for example, motor driving sound, in-vehicle announcement, regular vibration sound caused in a joint of railway tracks and door opening and closing sound are detected as environmental sound. Also, in the case of driving a private car with a passenger, running car noise, conversation with the passenger and car audio sound are detected as environmental sound. Further, even in a home, in the case of rain, regular rain sound hitting the roof and thunder may be detected as environmental sound.

Also, even in the case of taking the same action, environmental sound may vary between a case where a user puts an information terminal in a pocket to carry it and a case where it is put in a handbag to carry it. For example, in a case where the information terminal is put in a thick leather bag to carry it, the volume of detected environmental sound is small and sound quality with the suppressed high-frequency component may be acquired. Meanwhile, in the case of carrying it by hand, surrounding bustle and speaking voice with others may become likely to be captured. By using such environmental sound, it is possible to further enhance the accuracy of action pattern recognition. For example, in a motion sensor, even in a case where it is not possible to distinguish between boat roll and train roll, if water sound is heard, it is possible to easily decide that the roll is the boat roll.

As explained above, by using text information and environmental sound for action pattern recognition, it is possible to further enhance the accuracy of action pattern recognition. Especially, by updating a pattern DB storing information of motion/state patterns used by the above motion/state recognizing unit 112 and information of action patterns used by the action/situation recognizing unit 116, it is possible to realize higher accuracy of action pattern recognition. In the following, embodiments based on this technical idea are explained in more detail.

### 2: DETAILS OF EMBODIMENT

A technique according to the present embodiment is explained in detail.

### 2-1: Example of System Configuration

First, with reference to FIG. 14, a system configuration example of a system (i.e. action/situation recognition system 10) according to the present embodiment is introduced. FIG. 14 is an explanatory diagram for explaining a system configuration of the system (i.e. the action/situation recognition system 10) according to an embodiment. Also, the system configuration introduced herein is just an example and it is possible to apply a technique according to the present embodiment to various system configurations available now and in the future.

As illustrated in FIG. 14, the action/situation recognition system 10 mainly includes multiple information terminals CL and a server apparatus SV. The information terminal CL is an example of a device used by a user. As the information terminal CL, for example, a mobile phone, a smart phone, a digital still camera, a digital video camera, a personal computer, a table terminal, a car navigation system, a portable game device, health appliances (including a pedometer (registered trademark)) and medical equipment are assumed. Meanwhile, as the server apparatus SV, for example, a home server and a cloud computing system are assumed.

Naturally, a system configuration to which a technique according to the present embodiment is applicable is not limited to the example in FIG. 14, but, for convenience of explanation, an explanation is given with an assumption of the multiple information terminals CL and the server apparatus SV which are connected by wired and/or wireless networks. Therefore, a configuration is assumed in which it is possible to exchange information between the information terminals CL and the server apparatus SV. However, it is possible to employ a configuration such that, among various functions held by the action/situation recognition system 10, functions to be held by the information terminals CL and functions to be held by the server apparatus SV are freely designed. For example, it is desirable to design it taking into account the computing power and communication speed of the information terminals CL.

### 2-2: Updating of Pattern DB Using Text Information and Acoustic Information

In the following, a configuration and operation of the action/situation recognition system 10 are explained in more detail.

(2-2-1: Functional Configuration)

First, with reference to FIG. 15, a functional configuration of the action/situation recognition system 10 is explained. FIG. 15 is an explanatory diagram for explaining a functional configuration of the action/situation recognition system 10. Here, the function distribution between the information terminals CL and the server apparatus SV is not clearly specified and functions held by the action/situation recognition system 10 as a whole are explained.

As illustrated in FIG. 15, the action/situation recognition system 10 mainly includes an acoustic information acquiring unit 101, an acoustic information analyzing unit 102, a text information acquiring unit 103, a text information analyzing unit 104, a motion/state pattern updating unit 105, a motion/state pattern database 106, an action pattern updating unit 107 and an action pattern database 108.

Further, the action/situation recognition system 10 further includes a function of an action/situation analysis system 11. That is, the action/situation recognition system 10 further includes a motion sensor 111, a motion/state recognizing unit 112, a time information acquiring unit 113, a position sensor 114, a GIS information acquiring unit 115 and an action/situation recognizing unit 116. However, FIG. 15 clarifies a point that the motion/state recognizing unit 112 uses the motion/state pattern database 106. Further, it clarifies a point that the action/situation recognizing unit 116 uses the action pattern database 108.

The acoustic information acquiring unit 101 denotes a device to acquire environmental sound around the user. For example, the acoustic information acquiring unit 101 includes a microphone. An acoustic signal of the environmental sound acquired by the acoustic information acquiring unit 101 is input in the acoustic information analyzing unit 102. Here, before being input in the acoustic information analyzing unit 102, the environmental-sound acoustic signal may be converted from an analog speech waveform signal into a digital speech waveform signal. When the environmental-sound acoustic signal is input, the acoustic information analyzing unit 102 analyzes the input acoustic signal and estimates a user's action pattern.

For example, from the environmental-sound acoustic signal, the acoustic information analyzing unit 102 estimates whether the user is shopping, eating or getting on a train. For example, this estimation is performed using a learning model constructed by a machine learning method such as HMM. To be more specific, in the case of constructing a learning model to estimate an action pattern of “during shopping,” an acoustic signal actually collected during shopping is used. In this case, a seller's cry, shopper's conversation, escalator sound and sound caused at the time of taking an item from a shelf or hanger, are collected as environmental sound. The same applies to other action patterns.

Also, the acoustic information analyzing unit 102 estimates an action pattern (such as a motion/state pattern and an action/situation pattern) from the environmental-sound acoustic signal and, at the same time, calculates the certainty factor (i.e. evaluation score). Subsequently, the action pattern estimated from the environmental-sound acoustic signal and the certainty factor are input in the motion/state pattern updating unit 105 and the action pattern updating unit 107. Also, the above certainty factor indicates the similarity between the environmental-sound acoustic signal actually acquired by the acoustic information acquiring unit 101 and an acoustic signal corresponding to the estimated action pattern.

Meanwhile, the text information acquiring unit 103 acquires text information input by the user. For example, the text information acquiring unit 103 may denote an input device to input a text by the user or denote an information collection device to acquire text information from social network services or applications. Also, a device mounting a sensor and a device (such as a keyboard) to input a text may be separately provided. Here, for convenience of explanation, an explanation is given with an assumption that the text information acquiring unit 103 denotes an input unit such as a software keyboard. The text information acquired by the text information acquiring unit 103 is input in the text information analyzing unit 104. At this time, in the text information analyzing unit 104, the text information is input together with time information with respect to the time the text information is input.

When the text information is input, the text information analyzing unit 104 analyzes the input text information and estimates a user's action pattern (such as a motion/state pattern and an action/situation pattern). For example, from the input text information, the text information analyzing unit 104 estimates whether the user is shopping, eating or getting on a train. For example, this estimation is performed using a learning model constructed by a machine learning method such as SVM. To be more specific, in the case of constructing a learning model to estimate an action pattern of “during shopping,” text information input “during shopping” is collected and the collected text information is used as learning data. In this case, text information such as “bargain sale,” “expensive” and “busy checkout stand” is collected.

Also, the text information analyzing unit 104 estimates an action pattern from the text information and, at the same time, calculates the certainty factor (i.e. evaluation score). Subsequently, the action pattern estimated from the text information and the certainty factor are input in the motion/state pattern updating unit 105 and the action pattern updating unit 107. Also, the above certainty factor indicates the similarity between the text information actually acquired by the text information acquiring unit 103 and text information corresponding to the estimated action pattern.

As described above, the motion/state pattern updating unit 105 receives an input of the information indicating the action pattern and certainty factor acquired by the acoustic signal analysis (hereinafter referred to as “acoustic derivation information”) and the information indicating the action pattern and certainty factor acquired by the text information analysis (hereinafter referred to as “text derivation information”). Similarly, the action pattern updating unit 107 receives an input of the acoustic derivation information and the text derivation information. However, there is a possible case where an acoustic signal is not capable of being acquired or text information is not capable of being acquired. In such a case, information input in the motion information pattern updating unit 105 and the action pattern updating unit 107 is not limited to the acoustic derivation information or the text derivation information.

For example, in a case where the function of the acoustic information acquiring unit 101 is turned off or there is no device corresponding to the acoustic information acquiring unit 101, acoustic derivation information is not capable of being acquired. Also, in a case where the function of the text information acquiring unit 103 is turned off or there is no text information that can be acquired by the text information acquiring unit 103, text derivation information is not capable of being acquired. In such a case, the motion/state pattern updating unit 105 and the action pattern updating unit 107 perform update processing on the motion/state pattern database 106 and the action pattern database 108 using the input information.

(Case 1)

First, a case is described where only acoustic derivation information is acquired.

The motion/state pattern updating unit 105 compares the certainty factor of the acoustic signal and a predetermined threshold (hereinafter referred to as “first acoustic threshold”). In a case where the certainty factor of the acoustic signal is greater than the first acoustic threshold, the motion/state pattern updating unit 105 updates the motion/state pattern database 106 by the motion/state pattern acquired from the analysis result of the acoustic signal. By contrast, in a case where the certainty factor of the acoustic signal is less than the first acoustic threshold, the motion/state pattern updating unit 105 does not update the motion state pattern database 106. Thus, the motion/state pattern updating unit 105 decides whether to update the motion/state pattern database 106, according to the certainty factor of the acoustic signal.

Similarly, the action pattern updating unit 107 compares the certainty factor of the acoustic signal and a predetermined threshold (hereinafter referred to as “second acoustic threshold”). In a case where the certainty factor of the acoustic signal is greater than the second acoustic threshold, the action pattern updating unit 107 updates the action pattern database 108 by the action/situation pattern acquired from the analysis result of the acoustic signal. By contrast, in a case where the certainty factor of the acoustic signal is less than the second acoustic threshold, the action pattern updating unit 107 does not update the action pattern database 108. Thus, the action pattern updating unit 107 decides whether to update the action pattern database 108, according to the certainty factor of the acoustic signal.

Also, the first acoustic threshold and the second acoustic threshold may be different values. For example, in a case where an analysis result of sensor information is emphasized for a motion/state pattern and an analysis result of an acoustic signal is emphasized for an action/situation pattern, it is preferable to set the first acoustic threshold to be small and set the second acoustic threshold to be large. Meanwhile, in a case where the acoustic information acquiring unit 101 of high performance is used, the first and second acoustic thresholds are set to the same value, and, when the certainty factor equal to or greater than a certain level is acquired, it is preferable to update the motion/state pattern database 106 and the action pattern database 108 using the action pattern acquired by analyzing the acoustic signal.

(Case 2)

Next, a case is described where only text derivation information is acquired.

The motion/state pattern updating unit 105 compares the certainty factor of the text information and a predetermined threshold (hereinafter referred to as “first text information”). In a case where the certainty factor of the text information is greater than the first text threshold, the motion/state pattern updating unit 105 updates the motion/state pattern database 106 by the motion/state pattern acquired from the analysis result of the text information. By contrast, in a case where the certainty factor of the text information is less than the first text threshold, the motion/state pattern updating unit 105 does not update the motion state pattern database 106. Thus, the motion/state pattern updating unit 105 decides whether to update the motion/state pattern database 106, according to the certainty factor of the text information.

Similarly, the action pattern updating unit 107 compares the certainty factor of the text information and a predetermined threshold (hereinafter referred to as “second text threshold”). In a case where the certainty factor of the text information is greater than the second text threshold, the action pattern updating unit 107 updates the action pattern database 108 by the action/situation pattern acquired from the analysis result of the text information. By contrast, in a case where the certainty factor of the text information is less than the second text threshold, the action pattern updating unit 107 does not update the action pattern database 108. Thus, the action pattern updating unit 107 decides whether to update the action pattern database 108, according to the certainty factor of the text information.

Also, the first text threshold and the second text threshold may be different values. For example, in a case where an analysis result of sensor information is emphasized for a motion/state pattern and an analysis result of text information is emphasized for an action/situation pattern, it is preferable to set the first text threshold to be small and set the second text threshold to be large. Meanwhile, in a case where the text information acquiring unit 103 of high performance is used, the first and second text thresholds are set to the same value, and, when the certainty factor equal to or greater than a certain level is acquired, it is preferable to update the motion/state pattern database 106 and the action pattern database 108 using the action pattern acquired by analyzing the text information.

(Case 3)

Next, a case is described where both acoustic derivation information and text derivation information are acquired.

The motion/state pattern updating unit 105 compares the certainty factor of the acoustic signal and the first acoustic threshold. In a case where the certainty factor of the acoustic signal is greater than the first acoustic threshold, the motion/state pattern updating unit 105 prepares to update the motion/state pattern database 106 by the motion/state pattern acquired from the analysis result of the acoustic signal. Meanwhile, in a case where the certainty factor of the acoustic signal is less than the first acoustic threshold, the motion/state pattern updating unit 105 does not use the motion/state pattern acquired by analyzing the acoustic signal, in order to update the motion/state pattern database 106. Thus, the motion/state pattern updating unit 105 decides whether to update the motion/state pattern database 106, according to the certainty factor of the acoustic signal, but actual update processing is not immediately performed and is determined taking into account the certainty factor of the text information as described below.

Similar to decision processing related to the acoustic derivation information, the motion/state pattern updating unit 105 compares the certainty factor of the text information and the first text threshold. In a case where the certainty factor of the text information is greater than the first text threshold, the motion/state pattern updating unit 105 prepares to update the motion/state pattern database 106 by the motion/state pattern acquired from the analysis result of the text information. Meanwhile, in a case where the certainty factor of the text information is less than the first text threshold, the motion/state pattern updating unit 105 does not use the motion/state pattern acquired by analyzing the text information, in order to update the motion/state pattern database 106. Here, the motion/state pattern updating unit 105 performs update processing of the motion/state pattern database 106, taking into account the decision result related to the certainty factor of the acoustic signal and the decision result related to the certainty factor of the text information.

For example, in a case where the certainty factor of the acoustic signal is greater than the first acoustic threshold and the certainty factor of the text information is greater than the first text threshold, the motion/state pattern updating unit 105 compares the analysis result of the acoustic signal and the analysis result of the text information. If the motion/state pattern acquired by the acoustic signal analysis and the motion/state pattern acquired by the text information analysis are equal, the motion/state pattern updating unit 105 updates the motion/state pattern database 106 by the motion/state pattern.

Meanwhile, in a case where the motion/state pattern acquired by the acoustic signal analysis and the motion/state pattern acquired by the text information analysis are different, the motion/state pattern updating unit 105 compares the certainty factor of the acoustic signal and the certainty factor of the text information. For example, in a case where the certainty factor of the acoustic signal is greater than the certainty factor of the text information, the motion/state pattern updating unit 105 updates the motion/state pattern database 106 by the motion/state pattern acquired by the acoustic signal analysis. Meanwhile, in a case where the certainty factor of the acoustic signal is less than the certainty factor of the text information, the motion/state pattern updating unit 105 updates the motion/state pattern database 106 by the motion/state pattern acquired by the text information analysis.

For example, in a case where the certainty factor of the acoustic signal is greater than the first acoustic threshold and the certainty factor of the text information is less than the first text threshold, the motion/state pattern updating unit 105 updates the motion/state pattern database 106 by the motion/state pattern acquired by the acoustic signal analysis. Meanwhile, in a case where the certainty factor of the acoustic signal is less than the first acoustic threshold and the certainty factor of the text information is greater than the first text threshold, the motion/state pattern updating unit 105 updates the motion/state pattern database 106 by the motion/state pattern acquired by the text information analysis. Also, in a case where the certainty factor of the acoustic signal is less than the first acoustic threshold and the certainty factor of the text information is less than the first text threshold, the motion/state pattern updating unit 105 does not update the motion/state pattern database 106.

Similarly, the action pattern updating unit 107 compares the certainty factor of the acoustic signal and the first acoustic threshold. In a case where the certainty factor of the acoustic signal is greater than the first acoustic threshold, the action pattern updating unit 107 prepares to update the action pattern database 108 by the action/situation pattern acquired from the analysis result of the acoustic signal. Meanwhile, in a case where the certainty factor of the acoustic signal is less than the first acoustic threshold, the action pattern updating unit 107 does not use the action/situation pattern acquired by analyzing the acoustic signal, in order to update the action pattern database 108. Thus, the action pattern updating unit 107 decides whether to update the action pattern database 108, according to the certainty factor of the acoustic signal, but actual update processing is not immediately performed and is determined taking into account the certainty factor of the text information as described below.

The action pattern updating unit 107 performs update processing of the action pattern database 108, taking into account the decision result related to the certainty factor of the acoustic signal and the decision result related to the certainty factor of the text information. In a case where recognition of the certainty factor of the acoustic signal and recognition of the certainty factor of the text signal are different, the action pattern updating unit 107 does not update the action pattern database 108.

For example, in a case where the certainty factor of the acoustic signal is greater than the first acoustic threshold and the certainty factor of the text information is greater than the first text threshold, the action pattern updating unit 107 compares the analysis result of the acoustic signal and the analysis result of the text information. If the action/situation pattern acquired by the acoustic signal analysis and the action/situation pattern acquired by the text information analysis are equal, the action pattern updating unit 107 updates the action pattern database 108 by the action/situation pattern.

Meanwhile, in a case where the action/situation pattern acquired by the acoustic signal analysis and the action/situation pattern acquired by the text information analysis are different, the action pattern updating unit 107 compares the certainty factor of the acoustic signal and the certainty factor of the text information. Subsequently, in a case where recognition of the certainty factor of the acoustic signal and recognition of the certainty factor of the text signal are different, the action pattern updating unit 107 does not update the action pattern database 108.

For example, in a case where the certainty factor of the acoustic signal is greater than the first acoustic threshold and the certainty factor of the text information is less than the first text threshold, the action pattern updating unit 107 updates the action pattern database 108 by the motion/state pattern acquired by the acoustic signal analysis. Meanwhile, in a case where the certainty factor of the acoustic signal is less than the first acoustic threshold and the certainty factor of the text information is greater than the first text threshold, the action pattern updating unit 107 updates the action pattern database 108 by the action/situation pattern acquired by the text information analysis. Also, in a case where the certainty factor of the acoustic signal is less than the first acoustic threshold and the certainty factor of the text information is less than the first text threshold, the action pattern updating unit 107 does not update the action/situation pattern database 108.

Also, methods of setting the first and second acoustic thresholds and the first and second text thresholds are the same as in above cases 1 and 2.

The functional configuration of the action/situation recognition system 10 has been explained above. However, detailed explanation of a functional configuration corresponding to the action/situation analysis system 11 is omitted.

(2-2-2: Flow of Processing)

Next, with reference to FIG. 16 and FIG. 17, an operation of the action/situation recognition system 10 is explained. FIG. 16 and FIG. 17 are explanatory diagrams for explaining the operation of the action/situation recognition system 10. Here, the function distribution between the information terminals CL and the server apparatus SV is not clearly specified either and the entire operation of the action/situation recognition system 10 is explained. Also, an operation example is illustrated to clarify a flow of processing below, but, as estimated from explanation of the above functional configuration, the operation of the action/situation recognition system 10 is not limited to the example.

As illustrated in FIG. 16, the action/situation recognition system 10 decides whether the power is on (S101). When the power is on, the action/situation recognition system 10 moves processing to step S102. Meanwhile, in a case where the power is not on, the action/situation recognition system 10 returns the processing to step S101. In a case where the processing proceeds to step S102, the action/situation recognition system 10 acquires current time information by the function of the time information acquiring unit 113 (S102). Next, the action/situation recognition system 10 acquires position information of the current position by the function of the position sensor 114 (S103). Next, the action/situation recognition system 10 acquires GIS information of the current position by the function of the GIS information acquiring unit 115 (S104).

Next, the action/situation recognition system 10 acquires sensor information of the motion sensor by the function of the motion sensor 111 (S105). Next, the action/situation recognition system 10 recognizes a motion/state pattern using information stored in the motion/state pattern database 106, by the function of the motion/state recognizing unit 112 (S106). Next, the action/situation recognition system 10 estimates an action pattern using information stored in the action pattern database 108, by the function of the action/situation recognizing unit 116 (S107). After estimating the action pattern, the action/situation recognition system 10 moves the processing to step A.

When the processing proceeds to step A (see FIG. 17), the action/situation recognition system 10 acquires an acoustic signal of environmental sound by the function of the acoustic information acquiring unit 101 (S108). Next, the action/situation recognition system 10 acquires text information by the function of the text information acquiring unit 103 (S109). Next, the action/situation recognition system 10 acquires an environment estimation result (i.e. the above action pattern and the certainty factor (acoustic derivation information)) from the acoustic signal of the environmental sound by the function of the acoustic information analyzing unit 102, and decides whether the reliability (i.e. the above certainty factor) of the environment estimation result is greater than a predetermined threshold (i.e. the above acoustic threshold) (S110). In a case where the reliability is greater than the predetermined threshold, the action/situation recognition system 10 moves the processing to step S112. Meanwhile, in a case where the reliability is less than the predetermined threshold, the action/situation recognition system 10 moves the processing to step S111.

In the case of moving the processing to step S111, the action/situation recognition system 10 acquires a text analysis result (i.e. the above action pattern and the certainty factor (text derivation information)) by the function of the text information analyzing unit 104, and decides whether the reliability (i.e. the above certainty factor) of the text analysis result is greater than a predetermined threshold (i.e. the above text threshold) (S111). In a case where the reliability is greater than the predetermined threshold, the action/situation recognition system 10 moves the processing to step S112. Meanwhile, in a case where the reliability is less than the predetermined threshold, the action/situation recognition system 10 moves the processing to step S113.

In the case of moving the processing to step S112, the action/situation recognition system 10 updates the motion/state pattern database 106 and the action pattern database 108 by the functions of the motion/state pattern updating unit 105 and the action pattern updating unit 107 (S112), and moves the processing to step S113. The action/situation recognition system 10 that moves the processing to step S113 decides whether the power is turned off (S113). In a case where the power is turned off, the action/situation recognition system 10 finishes a series of processing related to action/situation recognition. Meanwhile, in a case where the power is not turned off, the action/situation recognition system 10 moves the processing to step B (see FIG. 16) and performs processing in step S102 and subsequent steps again.

The operation of the action/situation recognition system 10 has been explained above. Here, the order of processing related to the acoustic signal of the environmental sound and processing related to the text information may be reverse.

### Specific Example and Supplementary Explanation

In a case where the above technique is applied, for example, when “travel by train” is input as text information, the current user's action is decided as “train (boarding)” and the motion/state pattern database 106 is updated. To be more specific, with respect to the motion/state pattern “train (boarding)” registered in the motion/state pattern database 106, sensor information currently acquired from the motion sensor 111 is considered as additional data and action pattern learning is implemented. Also, even in a case where text information “having tea with a child in a department store” is input at around 3 pm on Sunday, the action pattern database 108 is updated.

Regarding motion/state patterns registered in advance, although patterns learned based on general usage of many users are registered, by performing adaptive processing using user's sensor information, it is updated by a motion/state pattern suitable to user's usage environment (for example, in a pocket or a bag) and it is possible to enhance the recognition accuracy of subsequent motion/state patterns or action/situation patterns.

Also, the acoustic information acquiring unit 101 may be used only when the motion/state pattern database 106 is updated or may be used to directly input information related to an acoustic signal of environmental sound in the motion/state recognizing unit 112 and directly estimate an action pattern by combining time-series data of the environmental sound and sensor information of a motion sensor. Also, although the embodiment to implement the motion/state recognition and the action/situation recognition in two stages has been illustrated, they may be implemented in one stage or only the motion/state recognition may be implemented. Such alternation naturally belongs to the technical scope of the present embodiment.

### 2-3: Alternation Example

### Application of Sound Recognition Technique

Next, an alternation example of the present embodiment is explained. The present alternation example relates to applied technology using a sound recognition technique. When the sound recognition technique is used, for example, it is possible to acquire text information in real time from user's speech or speech of the speech partner. Therefore, even for a user who does not input text information in a positive manner or even in a state where text information is not input, it is possible to update the pattern DB using text information and improve the action pattern recognition accuracy. In the following, a functional configuration and operation of the action/situation recognition system 10 according to the present alternation example are explained.

(2-3-1: Functional Configuration)

First, with reference to FIG. 18, a functional configuration of the action/situation recognition system 10 according to the present alternation example is explained. FIG. 18 is an explanatory diagram for explaining a detailed configuration of the action/situation recognition system 10 according to the present alternation example. Here, the function distribution between the information terminals CL and the server apparatus SV is not clearly specified and functions held by the action/situation recognition system 10 as a whole are explained.

As illustrated in FIG. 18, the action/situation recognition system 10 mainly includes the acoustic information acquiring unit 101, the acoustic information analyzing unit 102, the text information acquiring unit 103, the text information analyzing unit 104, the motion/state pattern updating unit 105, the motion/state pattern database 106, the action pattern updating unit 107, the action pattern database 108 and a sound recognizing unit 131. Further, the action/situation recognition system 10 includes the function of the action/situation analysis system 11. That is, the action/situation recognition system 10 according to the present alternation example and the action/situation recognition system 10 illustrated in FIG. 15 are different in that the sound recognizing unit 131 is provided or not.

The acoustic information acquiring unit 101 denotes a device to acquire environmental sound around the user. For example, the acoustic information acquiring unit 101 includes a microphone. An acoustic signal of the environmental sound acquired by the acoustic information acquiring unit 101 is input in the acoustic information analyzing unit 102 and the sound recognizing unit 131. Here, before being input in the acoustic information analyzing unit 102, the environmental-sound acoustic signal may be converted from an analog speech waveform signal into a digital speech waveform signal.

When the environmental-sound acoustic signal is input, the acoustic information analyzing unit 102 analyzes the input acoustic signal and estimates a user's action pattern. For example, from the environmental-sound acoustic signal, the acoustic information analyzing unit 102 estimates whether the user is shopping, eating or getting on a train. For example, this estimation is performed using a learning model constructed by a machine learning method such as HMM.

Also, the acoustic information analyzing unit 102 estimates an action pattern (such as a motion/state pattern and an action/situation pattern) from the environmental-sound acoustic signal and, at the same time, calculates the certainty factor (i.e. evaluation score). Subsequently, the action pattern estimated from the environmental-sound acoustic signal and the certainty factor are input in the motion/state pattern updating unit 105 and the action pattern updating unit 107. Also, the above certainty factor indicates the similarity between the environmental-sound acoustic signal actually acquired by the acoustic information acquiring unit 101 and an acoustic signal corresponding to the estimated action pattern.

Meanwhile, the text information acquiring unit 103 acquires text information input by the user. For example, the text information acquiring unit 103 may denote an input device to input a text by the user or denote an information collection device to acquire text information from social network services or applications. Also, the text information acquiring unit 103 may be formed so as to acquire, as text information, information such as the geographical name and the building name in the periphery of the current position from GIS information.

Further, in the case of the present alternation example, the text information acquiring unit 103 receives an input of text information, which is generated from the environmental-sound acoustic signal by the sound recognizing unit 131. For example, the sound recognizing unit 131 generates text information from the acoustic signal using a predetermined sound recognition technique, and inputs it in the text information acquiring unit 103. Thus, by providing the sound recognizing unit 131, the user can save the effort of inputting text information. Also, it is possible to acquire natural conversation made in an action, as text information, and therefore it is possible to acquire text information which is more suitable to an action pattern. Also, by converting announcement in a station or vehicle into text, it is expected to acquire useful information related to places or actions.

Also, although the above explanation introduces a configuration example to perform sound recognition with respect to an acoustic signal of environmental sound, it is possible to convert part or all of content of conversation, which is made using a calling function of the information terminal CL, into text by sound recognition. In this case, text information indicating the call content is input in the text information acquiring unit 103. For example, there are many cases where call content at the time of rendezvous includes information of the current position, time information or information such as an action object and the friend's name, and therefore it is possible to acquire information useful for estimating an action pattern. That is, by converting the call content into text information by the function of the sound recognizing unit 131 and using it to update the pattern DB, an effect of further improving the accuracy of action pattern recognition is expected.

The text information acquired as above by the text information acquiring unit 103 is input in the text information analyzing unit 104. At this time, in the text information analyzing unit 104, the text information is input together with time information with respect to the time the text information is input. When the text information is input, the text information analyzing unit 104 analyzes the input text information and estimates a user's action pattern (such as a motion/state pattern and an action/situation pattern). For example, this estimation is performed using a learning model constructed by a machine learning method such as SVM.

Also, the text information analyzing unit 104 estimates an action pattern from the text information and, at the same time, calculates the certainty factor (i.e. evaluation score). At this time, the certainty factor is calculated taking into consideration the certainty factor in sound recognition processing to convert an acoustic input into text. Subsequently, the action pattern estimated from the text information and the certainty factor are input in the motion/state pattern updating unit 105 and the action pattern updating unit 107. Also, the above certainty factor indicates the similarity between the text information actually acquired by the text information acquiring unit 103 and text information corresponding to the estimated action pattern.

As described above, the motion/state pattern updating unit 105 receives an input of the information indicating the action pattern and certainty factor acquired by the acoustic signal analysis (hereinafter referred to as “acoustic derivation information”) and the information indicating the action pattern and certainty factor acquired by the text information analysis (hereinafter referred to as “text derivation information”). Similarly, the action pattern updating unit 107 receives an input of the acoustic derivation information and the text derivation information. However, there is a possible case where an acoustic signal is not capable of being acquired or text information is not capable of being acquired. In such a case, information input in the motion information pattern updating unit 105 and the action pattern updating unit 107 is not limited to the acoustic derivation information or the text derivation information.

For example, in a case where the function of the acoustic information acquiring unit 101 is turned off or there is no device corresponding to the acoustic information acquiring unit 101, acoustic derivation information is not capable of being acquired. Also, in a case where the function of the text information acquiring unit 103 is turned off or there is no text information that can be acquired by the text information acquiring unit 103, text derivation information is not capable of being acquired. In such a case, the motion/state pattern updating unit 105 and the action pattern updating unit 107 perform update processing on the motion/state pattern database 106 and the action pattern database 108 using the input information.

The functional configuration of the action/situation recognition system 10 according to the present alternation example has been explained above. However, detailed explanation of a functional configuration corresponding to the action/situation analysis system 11 is omitted. Also, a method of updating the pattern DB is the same as that of the action/situation recognition system 10 illustrated in FIG. 15, and therefore its explanation is omitted.

(2-3-2: Flow of Processing)

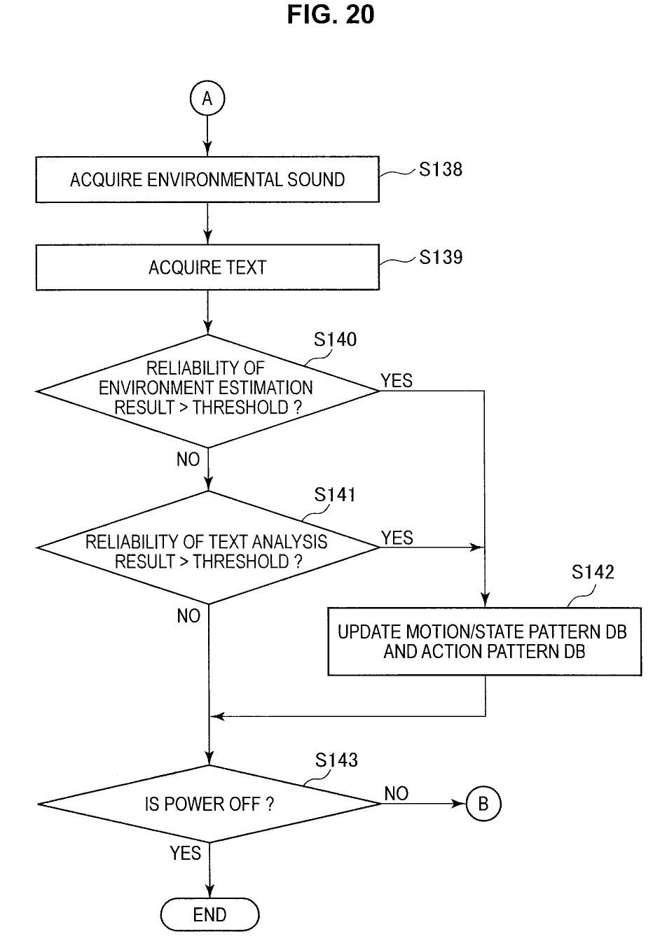

Next, with reference to FIG. 19 and FIG. 20, an operation of the action/situation recognition system 10 according to the present alternation example is explained. FIG. 19 and FIG. 20 are explanatory diagrams for explaining the operation of the action/situation recognition system 10 according to the present alternation example. Even here, the function distribution between the information terminals CL and the server apparatus SV is not clearly specified and functions held by the action/situation recognition system 10 as a whole are explained. Also, an operation example is illustrated to clarify a flow of processing below, but, as estimated from explanation of the above functional configuration, the operation of the action/situation recognition system 10 is not limited to the example.

As illustrated in FIG. 19, the action/situation recognition system 10 decides whether the power is on (S131). When the power is on, the action/situation recognition system 10 moves processing to step S132. Meanwhile, in a case where the power is not on, the action/situation recognition system 10 returns the processing to step S131. In a case where the processing proceeds to step S132, the action/situation recognition system 10 acquires current time information by the function of the time information acquiring unit 113 (S132). Next, the action/situation recognition system 10 acquires position information of the current position by the function of the position sensor 114 (S133). Next, the action/situation recognition system 10 acquires GIS information of the current position by the function of the GIS information acquiring unit 115 (S134).

Next, the action/situation recognition system 10 acquires sensor information of the motion sensor by the function of the motion sensor 111 (S135). Next, the action/situation recognition system 10 recognizes a motion/state pattern using information stored in the motion/state pattern database 106, by the function of the motion/state recognizing unit 112 (S136). Next, the action/situation recognition system 10 estimates an action pattern using information stored in the action pattern database 108, by the function of the action/situation recognizing unit 116 (S137). After estimating the action pattern, the action/situation recognition system 10 moves the processing to step A.

When the processing proceeds to step A (see FIG. 20), the action/situation recognition system 10 acquires an acoustic signal of environmental sound by the function of the acoustic information acquiring unit 101 (S138). Next, the action/situation recognition system 10 acquires text information by the function of the text information acquiring unit 103 (S139). In this alternation example, the text information includes information acquired by sound recognition processing. Next, the action/situation recognition system 10 acquires an environment estimation result (i.e. the above action pattern and the certainty factor (acoustic derivation information)) from the acoustic signal of the environmental sound by the function of the acoustic information analyzing unit 102, and decides whether the reliability (i.e. the above certainty factor) of the environment estimation result is greater than a predetermined threshold (i.e. the above acoustic threshold) (S140). In a case where the reliability is greater than the predetermined threshold, the action/situation recognition system 10 moves the processing to step S142. Meanwhile, in a case where the reliability is less than the predetermined threshold, the action/situation recognition system 10 moves the processing to step S141.

In the case of moving the processing to step S141, the action/situation recognition system 10 acquires a text analysis result (i.e. the above action pattern and the certainty factor (text derivation information)) by the function of the text information analyzing unit 104, and decides whether the reliability (i.e. the above certainty factor) of the text analysis result is greater than a predetermined threshold (i.e. the above text threshold) (S141). In a case where the reliability is greater than the predetermined threshold, the action/situation recognition system 10 moves the processing to step S142. Meanwhile, in a case where the reliability is less than the predetermined threshold, the action/situation recognition system 10 moves the processing to step S143.

In the case of moving the processing to step S142, the action/situation recognition system 10 updates the motion/state pattern database 106 and the action pattern database 108 by the functions of the motion/state pattern updating unit 105 and the action pattern updating unit 107 (S142), and moves the processing to step S143. The action/situation recognition system 10 that moves the processing to step S143 decides whether the power is turned off (S143). In a case where the power is turned off, the action/situation recognition system 10 finishes a series of processing related to action/situation recognition. Meanwhile, in a case where the power is not turned off, the action/situation recognition system 10 moves the processing to step B (see FIG. 19) and performs processing in step S132 and subsequent steps again.

The operation of the action/situation recognition system 10 has been explained above. Here, the order of processing related to the acoustic signal of the environmental sound and processing related to the text information may be reverse.

(Regarding Method of Identifying Data Interval of Update Target)

Here, a method of identifying a data interval of an update target is considered. Actually, in the case of updating a pattern DB, it is not easy to decide which interval of the time series of sensor data is suitable to be updated. For example, the user may remove the information terminal CL from a pocket, and, after inputting text information, put the information terminal CL in the pocket again. In this case, a user's action at the timing of inputting the text information is to input the text information, which is often different from an action pattern acquired by analysis of the input text information.

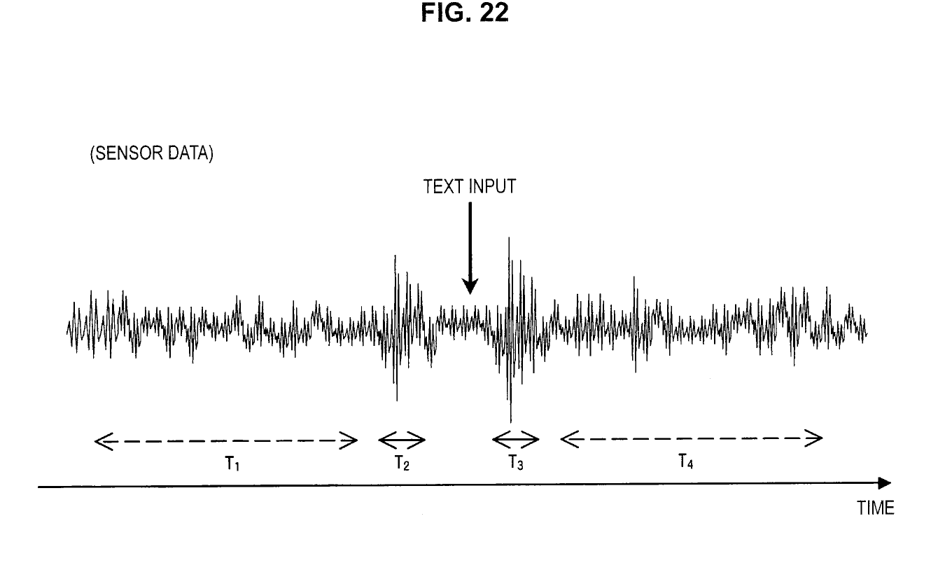

Therefore, there is suggested a method of focusing on an action at the time the user inputs text information and identifying which timing (i.e. update target data interval) an action pattern acquired by analyzing the text information corresponds to. For example, when the user's action as described above is assumed, it is considered that a time series of sensor data indicates a waveform as illustrated in FIG. 22. A period T1 denotes a period in which the information terminal CL is in a pocket, and corresponds to a past action pattern acquired by analyzing text information. Meanwhile, a period T4 denotes a period after text information is input and the information terminal CL is put in the pocket, and corresponds to a future action pattern acquired by analyzing the text information.

Also, a period T2 denotes a period in which the information terminal CL is being put out from the pocket. Therefore, large waveform variation is found in the sensor data. Meanwhile, a period T3 denotes a period in which the information terminal CL is being put in the pocket. Therefore, large waveform variation is found in the sensor data. Normally, when the text information is input, the information terminal CL is maintained in a steady state. Therefore, by detecting periods in which the information terminal CL is taken in and out (i.e. periods T2 and T3), it is possible to detect a period in which the text information is input, at relatively high accuracy. Also, it is considered that, by considering the waveform similarity between periods T1 and T4, it is possible to detect an input period of the text information more accurately.

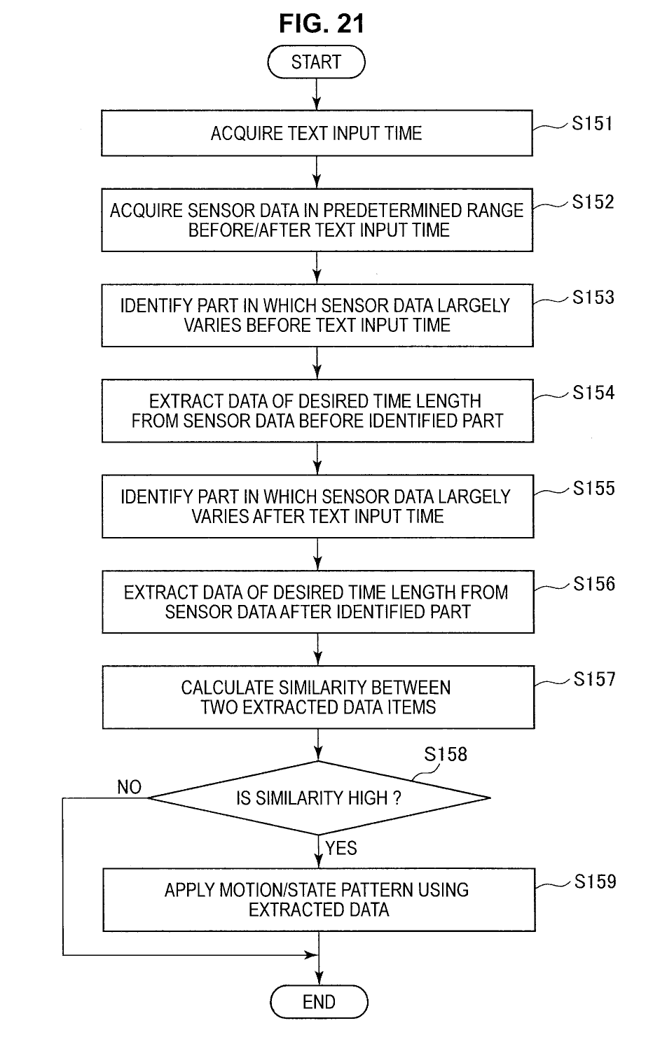

As a method of identifying an update target data interval based on such consideration, a processing method as illustrated in FIG. 21 is suggested. Here, for convenience of explanation, although an action of putting out the information terminal CL from the pocket or putting it in the pocket has been described as an example, the same applies to a case where, in addition to the pocket, it is put in a bag, attaché case, trunk or porch to carry it.

As illustrated in FIG. 21, the action/situation recognition system 10 acquires the text input time (S151). Next, the action/situation recognition system 10 acquires sensor data in a predetermined range before and after the text input time (S152). Next, the action/situation recognition system 10 identifies a part in which the sensor data largely varies before the text input time (S153). For example, in a case where a value of the sensor data is over a predetermined threshold, the action/situation recognition system 10 identifies the corresponding area as a part in which it largely varies. Also, in addition to threshold decision, a method of using spectrogram analysis is possible.

Next, the action/situation recognition system 10 extracts data of a desired time length from the sensor data before the identified part (S154). Next, the action/situation recognition system 10 identifies a part in which the sensor data largely varies after the text input time (S155). Next, the action/situation recognition system 10 extracts data of a desired time length from the sensor data after the identified part (S156). Next, the action/situation recognition system 10 calculates the similarity between two extracted items of data (S157). For example, the action/situation recognition system 10 decides the similarity on a spectrogram or calculates a cross-correlation coefficient and decides the similarity.

Next, the action/situation recognition system 10 decides whether the similarity is high (S158). In a case where the similarity is high, the action/situation recognition system 10 moves the processing to step S159. By contrast, in a case where the similarity is low, the action/situation recognition system 10 finishes a series of processing to identify the update target data interval. In the case of moving the processing to step S159, the action/situation recognition system 10 adapts a motion/state pattern using the extracted data (S159) and finishes a series of processing to identify the update target data interval.

The similarity is checked in step S158 because the user's action may vary before or after the text input. By performing such a check, even in a case where it is erroneously decided whether text description content relates to an action before the text input or it relates to an action after the text input, it is possible to prevent a motion/state pattern from being adapted by inappropriate sensor data.

In addition, as a preventive measure not to implement adaptive processing in an erroneous sensor data interval, for example, there is a possible method of avoiding updating sensor data that is extremely different from a motion/state pattern registered in the motion/state pattern database 106 before adaptation. To realize this method, for example, processing similar to the above reliability calculation may be implemented, and, in a case where the reliability is not over a predetermined threshold, adaptive processing may not be performed. Thus, alternation to apply various measurements to prevent erroneous adaptation is possible.

The operation of the action/situation recognition system 10 has been explained above.

### 2-4: Example of Screen Display

### One Example of Application

When the above action/situation recognition system 10 is used, for example, it is possible to realize an application as illustrated in FIG. 23. FIG. 23 illustrates an example of a UI (User Interface) screen of a certain information terminal CL. This screen displays objects representing multiple characters M1 to M6. In this example, characters M1 to M5 are running. Character M2 is walking. Character M3 is lying down. Characters M4 and M6 are squatting down. The action of each character reflects a result of analysis in the action/situation recognition system 10 using information acquired at the time the user corresponding to each character holds the information terminal CL.

When the action/situation recognition system 10 is applied to an application as illustrated in FIG. 23, the user can let other users to know the user's action, without performing a special operation to specify the user's action. For example, at the time of thinking of asking someone out for a drink, by talking to a character whose action pattern seems to be free, the character accepts the invitation with a higher probability. Further, at the time of searching a speech partner, it is possible to preliminarily make consideration to avoid a character taking a busy action pattern. Although other various application examples are possible, an example applied to the application as illustrated in FIG. 23 has been introduced.

Details of the technique according to the present embodiment have been explained above.

### 3: EXAMPLE HARDWARE CONFIGURATION

Functions of each constituent included in the action/situation analysis system 10, the information terminal CL, and the server apparatus SV described above can be realized by using, for example, the hardware configuration of the information processing apparatus shown in FIG. 24. That is, the functions of each constituent can be realized by controlling the hardware shown in FIG. 24 using a computer program. Additionally, the mode of this hardware is arbitrary, and may be a personal computer, a mobile information terminal such as a mobile phone, a PHS or a PDA, a game machine, or various types of information appliances. Moreover, the PHS is an abbreviation for Personal Handy-phone System. Also, the PDA is an abbreviation for Personal Digital Assistant.

As shown in FIG. 24, this hardware mainly includes a CPU 902, a ROM 904, a RAM 906, a host bus 908, and a bridge 910. Furthermore, this hardware includes an external bus 912, an interface 914, an input unit 916, an output unit 918, a storage unit 920, a drive 922, a connection port 924, and a communication unit 926. Moreover, the CPU is an abbreviation for Central Processing Unit. Also, the ROM is an abbreviation for Read Only Memory. Furthermore, the RAM is an abbreviation for Random Access Memory.

The CPU 902 functions as an arithmetic processing unit or a control unit, for example, and controls entire operation or a part of the operation of each structural element based on various programs recorded on the ROM 904, the RAM 906, the storage unit 920, or a removal recording medium 928. The ROM 904 is a mechanism for storing, for example, a program to be loaded on the CPU 902 or data or the like used in an arithmetic operation. The RAM 906 temporarily or perpetually stores, for example, a program to be loaded on the CPU 902 or various parameters or the like arbitrarily changed in execution of the program.

These structural elements are connected to each other by, for example, the host bus 908 capable of performing high-speed data transmission. For its part, the host bus 908 is connected through the bridge 910 to the external bus 912 whose data transmission speed is relatively low, for example. Furthermore, the input unit 916 is, for example, a mouse, a keyboard, a touch panel, a button, a switch, or a lever. Also, the input unit 916 may be a remote control that can transmit a control signal by using an infrared ray or other radio waves.

The output unit 918 is, for example, a display device such as a CRT, an LCD, a PDP or an ELD, an audio output device such as a speaker or headphones, a printer, a mobile phone, or a facsimile, that can visually or auditorily notify a user of acquired information. Moreover, the CRT is an abbreviation for Cathode Ray Tube. The LCD is an abbreviation for Liquid Crystal Display. The PDP is an abbreviation for Plasma Display Panel. Also, the ELD is an abbreviation for Electro-Luminescence Display.

The storage unit 920 is a device for storing various data. The storage unit 920 is, for example, a magnetic storage device such as a hard disk drive (HDD), a semiconductor storage device, an optical storage device, or a magneto-optical storage device. The HDD is an abbreviation for Hard Disk Drive.

The drive 922 is a device that reads information recorded on the removal recording medium 928 such as a magnetic disk, an optical disk, a magneto-optical disk, or a semiconductor memory, or writes information in the removal recording medium 928. The removal recording medium 928 is, for example, a DVD medium, a Blu-ray medium, an HD-DVD medium, various types of semiconductor storage media, or the like. Of course, the removal recording medium 928 may be, for example, an electronic device or an IC card on which a non-contact IC chip is mounted. The IC is an abbreviation for Integrated Circuit.

The connection port 924 is a port such as an USB port, an IEEE1394 port, a SCSI, an RS-232C port, or a port for connecting an externally connected device 930 such as an optical audio terminal. The externally connected device 930 is, for example, a printer, a mobile music player, a digital camera, a digital video camera, or an IC recorder. Moreover, the USB is an abbreviation for Universal Serial Bus. Also, the SCSI is an abbreviation for Small Computer System Interface.

The communication unit 926 is a communication device to be connected to a network 932, and is, for example, a communication card for a wired or wireless LAN, Bluetooth (registered trademark), or WUSB, an optical communication router, an ADSL router, or a modem for various communication. The network 932 connected to the communication unit 926 is configured from a wire-connected or wirelessly connected network, and is the Internet, a home-use LAN, infrared communication, visible light communication, broadcasting, or satellite communication, for example. Moreover, the LAN is an abbreviation for Local Area Network. Also, the WUSB is an abbreviation for Wireless USB. Furthermore, the ADSL is an abbreviation for Asymmetric Digital Subscriber Line.

### 4: CONCLUSION

Finally, the technical idea of the present embodiment is simply summarized. The technical idea described below is applicable to various information processing apparatuses such as a PC, a mobile phone, a portable game device, a portable information terminal, an information appliance and a car navigation.

Additionally, the present technology may also be configured as below.

(1) An information processing apparatus including:

a DB updating unit updating an action pattern database used to detect an action pattern of a user based on a sensor detection result;

a text information acquiring unit acquiring text information which the user inputs in a device; and

a text information analyzing unit acquiring information related to an action pattern from the text information,

wherein, in a case where the information related to the action pattern is acquired from the text information, the DB updating unit updates the action pattern database using the acquired information.

(2) The information processing apparatus according to (1),

wherein the text information analyzing unit calculates a first reliability of the information related to the action pattern, and

wherein, in a case where the first reliability is over a first predetermined threshold, the DB updating unit updates the action pattern database using the information related to the action pattern, which is acquired from the text information.

(3) The information processing apparatus according to (1) or (2), further including:

a sound information acquiring unit acquiring information related to a sound detected by the device; and

a sound information analyzing unit acquiring information related to an action pattern from the information related to the sound,

wherein, in a case where the information related to the action pattern is acquired from the information related to the sound, the DB updating unit updates the action pattern database using the acquired information.

(4) The information processing apparatus according to (3),

wherein the sound information analyzing unit calculates a second reliability of the information related to the action pattern, and

wherein, in a case where the second reliability is over a second predetermined threshold, the DB updating unit updates the action pattern database using the information related to the action pattern, which is acquired from the information related to the sound.

(5) The information processing apparatus according to (3) or (4), further including:

a sound recognizing unit converting the information related to the sound into text information,

wherein the text information analyzing unit acquires the information related to the action pattern, from the text information converted by the sound recognizing unit and the text information acquired by the text information acquiring unit.

(6) An electronic device including:

a communication unit accessing an action pattern database used to detect an action pattern of a user based on a sensor detection result in a case where information related to an action pattern is acquired from text information which the user inputs in the electronic device, the action pattern database being updated using the acquired information; and

an action pattern information acquiring unit acquiring the information related to the action pattern corresponding to the sensor detection result and the text information, from the action pattern database.

(7) An information processing method including:

updating an action pattern database used to detect an action pattern of a user based on a sensor detection result,

wherein, in a case where information related to an action pattern is acquired from text information which the user inputs in a device, the action pattern database is updated using the acquired information.

(8) An information processing method including:

accessing an action pattern database used to detect an action pattern of a user based on a sensor detection result in a case where information related to an action pattern is acquired from text information which the user inputs in an electronic device, the action pattern database being updated using the acquired information; and

acquiring the information related to the action pattern corresponding to the sensor detection result and the text information, from the action pattern database.

(9) A program for causing a computer to realize:

a DB updating function of updating an action pattern database used to detect an action pattern of a user based on a sensor detection result;

a text information acquiring function of acquiring text information which the user inputs in a device; and

a text information analyzing function of acquiring information related to an action pattern from the text information,

wherein, in a case where the information related to the action pattern is acquired from the text information, the DB updating function updates the action pattern database using the acquired information.

(10) A program for causing a computer to realize:

a communication function of accessing an action pattern database used to detect an action pattern of a user based on a sensor detection result in a case where information related to an action pattern is acquired from text information which the user inputs in an electronic device, the action pattern database being updated using the acquired information; and

an action pattern information acquiring function of acquiring the information related to the action pattern corresponding to the sensor detection result and the text information, from the action pattern database.

(Remarks)

The above action pattern updating unit 107 is an example of a DB updating unit. The above acoustic information acquiring unit 101 is an example of a sound information acquiring unit. The above acoustic information analyzing unit 102 is an example of a sound information analyzing unit.

Although the preferred embodiments of the present disclosure have been described in detail with reference to the appended drawings, the present disclosure is not limited thereto. It is obvious to those skilled in the art that various modifications or variations are possible insofar as they are within the technical scope of the appended claims or the equivalents thereof. It should be understood that such modifications or variations are also within the technical scope of the present disclosure.

The present disclosure contains subject matter related to that disclosed in Japanese Priority Patent Application JP 2012-129799 filed in the Japan Patent Office on Jun. 7, 2012, the entire content of which is hereby incorporated by reference.

1. An information processing apparatus comprising:
a DB updating unit updating an action pattern database used to detect an action pattern of a user based on a sensor detection result;
a text information acquiring unit acquiring text information which the user inputs in a device; and
a text information analyzing unit acquiring information related to an action pattern from the text information,
wherein, in a case where the information related to the action pattern is acquired from the text information, the DB updating unit updates the action pattern database using the acquired information.

2. The information processing apparatus according to claim 1,
wherein the text information analyzing unit calculates a first reliability of the information related to the action pattern, and
wherein, in a case where the first reliability is over a first predetermined threshold, the DB updating unit updates the action pattern database using the information related to the action pattern, which is acquired from the text information.

3. The information processing apparatus according to claim 1, further comprising:
a sound information acquiring unit acquiring information related to a sound detected by the device; and
a sound information analyzing unit acquiring information related to an action pattern from the information related to the sound,
wherein, in a case where the information related to the action pattern is acquired from the information related to the sound, the DB updating unit updates the action pattern database using the acquired information.

4. The information processing apparatus according to claim 3,
wherein the sound information analyzing unit calculates a second reliability of the information related to the action pattern, and
wherein, in a case where the second reliability is over a second predetermined threshold, the DB updating unit updates the action pattern database using the information related to the action pattern, which is acquired from the information related to the sound.

5. The information processing apparatus according to claim 3, further comprising:
a sound recognizing unit converting the information related to the sound into text information,
wherein the text information analyzing unit acquires the information related to the action pattern, from the text information converted by the sound recognizing unit and the text information acquired by the text information acquiring unit.

6. An electronic device comprising:
a communication unit accessing an action pattern database used to detect an action pattern of a user based on a sensor detection result in a case where information related to an action pattern is acquired from text information which the user inputs in the electronic device, the action pattern database being updated using the acquired information; and
an action pattern information acquiring unit acquiring the information related to the action pattern corresponding to the sensor detection result and the text information, from the action pattern database.

7. An information processing method comprising:
updating an action pattern database used to detect an action pattern of a user based on a sensor detection result,
wherein, in a case where information related to an action pattern is acquired from text information which the user inputs in a device, the action pattern database is updated using the acquired information.

8. (canceled)

9. (canceled)

10. (canceled)
